(19) United States
(12) Patent Application Publication
(10) Pub. No.: US 2025/0263848 A1
(43) Pub. Date: Aug. 21, 2025

(54) SYSTEM, APPARATUS, AND METHOD TO CREATE SYNTHETIC FUEL

(71) Applicant: HUNT ENERGY ENTERPRISES, L.L.C., Dallas, TX (US)

(72) Inventors: Michael D. Irwin, Heath, TX (US); Michael Graetzel, Vaud (CH); Jing Gao, Vaud (CH); Pablo Jiménez-Calvo, Nuremberg (DE); Senthilkumar Pachamuthu, Lausanne (CH)

(21) Appl. No.: 18/815,616

(22) Filed: Aug. 26, 2024

Related U.S. Application Data
(63) Continuation-in-part of application No. 18/732,290, filed on Jun. 3, 2024.
(60) Provisional application No. 63/556,105, filed on Feb. 21, 2024.

(51) Int. Cl. C25B 1/23; B01J 27/24; C25B 9/50

(52) U.S. Cl. CPC C25B 1/23; B01J 27/24; C25B 9/50; B01J 2523/18; B01J 2523/19

(57) ABSTRACT

Particular embodiments described herein provide for a synthetic fuel creation system. The synthetic fuel creation system includes a syngas creation station to create syngas, a crude creation station to create heavy syncrude, and a crude cracking station to convert the heavy syncrude into synthetic fuel. The synthetic fuel creation system can use an electrocatalysis system to create the syngas and the electrocatalysis system can include an anode, a cathode, oxygen evolution reaction catalysts, hydrogen/carbon monoxide evolution reaction catalysts, and an electrolyte, where the hydrogen/carbon monoxide evolution reaction catalysts include a graphitic carbon nitride.

### CROSS-REFERENCE TO SEVERAL RELATED APPLICATIONS

This disclosure is a Continuation in Part (CIP) of Utility patent application Ser. No. 18/732,290, entitled “SYSTEM, APPARATUS, AND METHOD TO CREATE SYNTHETIC FUEL” filed in the United States Patent Office on Jun. 3, 2024, and thereby claims all benefits and priority to which it is entitled including any and all provisions of the CFR, including at least 37 CFR 1.53 and this disclosure further relates, and claims the benefit of priority to, Provisional Application No. 63/556,105, entitled “CATALYST FOR USE IN SYNGAS PRODUCTION” filed in the United States Patent Office on Feb. 21, 2024. Both of the aforementioned Applications are hereby incorporated by reference in their entireties.

### TECHNICAL FIELD

This disclosure relates in general to the field of energy and, more particularly, to a system, an apparatus, and a method to create synthetic fuel.

### BACKGROUND

Electro fuels (e-fuels) are a class of synthetic fuels that can be a type of drop-in replacement fuel. E-Fuels are manufactured using synthesis gas (syngas). Syngas is a mixture of hydrogen and carbon monoxide (CO) in various ratios. Captured carbon dioxide can also be used to create synthetic e-Fuel and when the synthetic e-fuel is burned, approximately the same amount of carbon dioxide is released into the air for an overall low carbon footprint. E-fuels do not come from fossil energy sources and, instead, are generally obtained from a chemical process based on hydrogen and carbon dioxide.

E-fuels are typically produced with the help of electricity from renewable energy sources, water, and carbon dioxide (CO₂) from the air. Unlike conventional fuels, they do not release additional CO₂, but are climate neutral or close to climate neutral. Due to their compatibility with today's internal combustion engines, e-Fuels can also power vehicles, airplanes, and ships, thus allowing internal combustion engines to continue to operate but in a more climate-friendly manner. Hence, e-Fuels can offer ecological and economic benefits as they are climate-friendly, compatible with conventional engines, and relatively easy to use. Also, usage of e-fuels does not require any conversion of existing transport, distribution, and fuel/gas infrastructures.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIGS. 1A-1C are simplified block diagrams of systems to create synthetic fuel, in accordance with an embodiment of the present disclosure;

FIG. 2 is simplified block diagram illustrating example details of a portion of the system to create synthetic fuel, in accordance with an embodiment of the present disclosure;

FIG. 3A is a simplified block diagram illustrating example details of a PV-driven electrocatalysis system to create synthetic gas, in accordance with an embodiment of the present disclosure;

FIG. 3B is a simplified block diagram illustrating example details of a PV-driven electrocatalysis system to create synthetic gas, in accordance with an embodiment of the present disclosure;

FIG. 4 is a simplified block diagram illustrating example details of a portion of a portion of a crude creation station, in accordance with an embodiment of the present disclosure;

FIG. 5 is a simplified block diagram illustrating example details of a portion of a crude refining station, in accordance with an embodiment of the present disclosure;

FIGS. 6A and 6B are a simplified block diagram illustrating example details of a portion of a direct air capture (DAC) system to capture carbon dioxide to be used by the system to create synthetic fuel, in accordance with an embodiment of the present disclosure;

FIG. 7 is a simplified block diagram illustrating example details of a portion of a reaction vessel in an electrocatalysis system, in accordance with an embodiment of the present disclosure;

FIG. 8 is a simplified block diagram illustrating example details of a portion of a reaction vessel in an electrocatalysis system, in accordance with an embodiment of the present disclosure;

FIG. 9 is a simplified block diagram illustrating example details of a portion of a reaction vessel in an electrocatalysis system, in accordance with an embodiment of the present disclosure;

FIG. 10 is a simplified block diagram illustrating example details of a portion of a reaction vessel in an electrocatalysis system, in accordance with an embodiment of the present disclosure;

FIG. 11 is a simplified block diagram illustrating example details of a portion of a reaction vessel in an electrocatalysis system, in accordance with an embodiment of the present disclosure;

FIG. 12 is a simplified block diagram illustrating example details of a particular non-limiting implementation of a portion of a zero gap PEM electrolyzer, in accordance with an embodiment of the present disclosure;

FIG. 13 is a simplified block diagram illustrating example details of a portion of a reaction vessel in an electrocatalysis system, in accordance with an embodiment of the present disclosure;

FIG. 14 is a simplified block diagram illustrating example details of a simplified table illustrating example details relating to reactions in a reaction vessel of an electrocatalysis system to help create syngas, in accordance with an embodiment of the present disclosure;

FIG. 15 is a simplified graph illustrating particular non-limiting example details of H₂, CO, and CH₄ distributions at different current densities during creation of the syngas using a graphitic carbon nitride catalyst, in accordance with an embodiment of the present disclosure;

FIG. 16 is a simplified graph illustrating particular non-limiting example details of H₂, CO, and CH₄ distributions at different carbon dioxide flow rates during creation of the syngas using a graphitic carbon nitride catalyst, in accordance with an embodiment of the present disclosure;

FIG. 17 is a simplified is a simplified graph illustrating particular non-limiting example details of the durability of a graphitic carbon nitride catalyst during creation of the syngas, in accordance with an embodiment of the present disclosure;

FIG. 18 is a simplified graph illustrating particular non-limiting example details of H₂, CO, and CH₄ distributions at different current densities during creation of the syngas using a graphitic carbon nitride catalyst, in accordance with an embodiment of the present disclosure;

FIG. 19 is a simplified graph illustrating particular non-limiting example details of H₂, CO, and CH₄ distributions at different current densities during creation of the syngas using a graphitic carbon nitride catalyst I, in accordance with an embodiment of the present disclosure;

FIG. 20 is a simplified graph illustrating particular non-limiting example details of using a bare carbon nitride catalyst at different current densities, in accordance with an embodiment of the present disclosure;

FIG. 21 is a simplified diagram illustrating the structure of g-C₃N₄, in accordance with an embodiment of the present disclosure;

FIG. 22 is a simplified flowchart illustrating potential operations that may be associated with the system, in accordance with an embodiment of the present disclosure;

FIG. 23 is a simplified flowchart illustrating potential operations that may be associated with the system, in accordance with an embodiment of the present disclosure; and

FIG. 24 is a simplified flowchart illustrating potential operations that may be associated with the system, in accordance with an embodiment of the present disclosure.

The FIGURES of the drawings are not necessarily drawn to scale, as their dimensions can be varied considerably without departing from the scope of the present disclosure.

### DETAILED DESCRIPTION

The following detailed description sets forth examples of apparatuses, methods, and systems relating to a process to create synthetic fuel in accordance with an embodiment of the present disclosure. Features such as structure(s), function(s), and/or characteristic(s), for example, are described with reference to one embodiment as a matter of convenience; various embodiments may be implemented with any suitable one or more of the described features.

### Overview

Photoelectrochemical conversion of carbon dioxide (CO₂) to syngas (H₂/CO) is an attractive path to low-carbon fuels. However, the development of efficient and stable electrocatalysts for syngas electrochemical conversion remains a challenge. Currently there is a need to create low carbon intensity fuels and store daytime photovoltaic (PV) energy in chemical bonds for deployment-on-demand. One means of creating low carbon intensity fuels is to utilize electrocatalytic devices to convert water and carbon dioxide into synthesis gas (syngas). Prevalent in the chemical industry, syngas is mixture of carbon monoxide (CO) and hydrogen gases. In an example, the syngas can be utilized in a Fischer-Tropsch reaction for fuels and lubricants, utilized to produce polymers (e.g., polycarbonate), utilized to make alcohols (e.g., MeOH), burned directly as a fuel, utilized in iron refining, utilized in a Haber-Bosch process, and utilized to produce other compounds and/or processes. In other examples, the syngas can be used for power generation (e.g., gas turbine, internal combustion engine, fuel cells, etc.), used to produce hydrogen (e.g., a Syngas redox (SGR) process) for use in refinery hydrotreating, used in fuel cells, used to create chemicals, fertilizers, transportation fuels, etc., used to produce methanol, used to produce ethanol, and/or other uses for the syngas. Currently, syngas is typically produced through steam-methane reforming (SMR) or coal gasification using the reaction CH₄+H₂O→CO+3H₂.

The current means of producing syngas is a carbon-intense process producing about 5 to about 15 mol % carbon dioxide and emitting about 38 mol % to about 77 mol % anthropogenic CO₂, assuming natural gas turbine electricity at about 60 to about 30% efficiency, respectively on a methane basis. What is needed is a process or means to reduce the carbon intensity of the creation of syngas. One way to reduce the carbon intensity of the syngas creation process is through PV-driven electrocatalysis and utilizing CO₂ as a precursor for net-zero production.

One type of PV-driven electrocatalysis system that may be employed is a PV-integrated electrocatalysis system. Another type of PV-driven electrocatalysis system that may be employed is a PV-divorced electrocatalysis system. Note that other PV-integrated electrocatalysis systems may be employed and the PV-integrated electrocatalysis system and the PV-divorced electrocatalysis system are used as non-limiting examples.

The PV-integrated electrocatalysis system (PVIE) and the PV-divorced electrocatalysis system (PV-EC) are similar in construction with a polymer electrolyte membrane equalizer (PEM) with the addition of a shared electrode between the PV cell and the integrated PEM. In an example, the PV-ECs and the PVIEs can be used to split water and reduce CO₂ and can comprise four or five core components. More specifically, the PV-ECs and the PVIEs can include an oxygen evolution reaction (OER) electrode (anode) with catalyst, a hydrogen/carbon moxoxide evolution reaction (HCER) electrode (cathode) with catalyst, electrolyte, reaction separating membrane, and, in the case of PVIEs, an integrated PV cell.

OER reaction: 2H₂O→O₂+4H⁺

HCER reaction: 4H⁺+CO₂→H₂+CO+H₂O

PVIEs specifically consist of an integrated photoabsorber/catalyst interface which can absorb the incident solar flux and directly generate molecules, such as H₂, CO, methanol, ethanol, propanol, formic acid, acetic acid, ethylene, propene, methane, ethane, and propane at the required potential, as opposed to generating electricity in typical PV applications. An advantage of an integrated PVIE, in contrast to a divorced PV-EC system, is the potential to harvest PV cell heat by the reaction solution, which can boost the efficiency of catalysts used in the system by reducing the voltage requirements (i.e., overpotential) to drive the electrolysis reaction. Another advantage of an integrated PVIE, in contrast to a divorced PV-EC system, is the ability to cool the PV cell to increase its efficiency. Yet another advantage of an integrated PVIE, in contrast to a divorced PV-EC system, is that PVIEs facilitate low loadings of precious metal catalysts because they operate at low current densities (J=15 to 30 mA/cm²) compared with dark electrolyzers (J>1 A/cm²). A high-efficiency PVIE can be achieved using multijunction group III-V semiconductor-based PV cells (e.g., GaAs), which can have an exhibited solar-to-hydrogen (STH) efficiency of about 19% on small area (i.e., 0.1 cm²) devices.

Recent results of performance tests on some PVIEs have demonstrated a STH efficiency of 20.8% (LBNL-certified) on 1 cm² active area with >100 hours of continuous operation using low-cost ($30/m², 2023 US dollars) two-terminal (2T) metal halide perovskite (MHP) and silicon (Si) tandem PV cells. Both the record efficiency and durability were enabled by a conductive adhesive barrier (CAB), which facilitates near perfect translation of electrical power from a two terminal (2T) tandem electrode to drive unassisted water splitting. PV-EC (CO₂) over a CuSn oxide HCER catalyst with solar-to-chemical (STC) efficiencies equal to about 20% to CO has also been demonstrated with nearly unity Faradaic efficiency. Conversion rates of about 300 g*hr⁻¹m⁻² have also been demonstrated. At such high STC efficiencies, existing catalysts for the CO₂ reduction reaction can be leveraged under acidic conditions and supplemented with an external H₂ source to achieve the desired H₂/CO ratio for the target syngas application. Currently known CO₂ reduction schemes, where CO is the target molecule, are typically performed under alkaline conditions to avoid H₂ production and yield carbonate as an energy-sink byproduct. If the CO₂ reduction reaction is performed under acidic conditions, H₂ is formed in low yield; which is the desired reaction and the H₂ yield can be increased as desired through process and catalyst optimization.

The fundamentals of the syngas creation system are based on improved catalyst design and durability/efficiency at-scale. For example, bimetallic catalysts have shown great potential for the electrochemical reduction of CO₂ in CO, formic acid (HCOOH), methane and ethylene (C₂H₄). The combination of two metals can synergistically enhance catalytic performance and product selectivity to CO. More specifically, the bimetallic catalysts, CuSn, AuAg and NiFe and NiCu have been shown to exhibit excellent selectivity towards the production of CO. The presence of Cu can promote the activation of the reactants and suppress the formation of carbon deposits, while nickel can enhance the hydrogenation and reforming reactions. Currently, most PV-EC work in this area is performed under alkaline conditions (pH>7) to suppress H₂ production to the cost of bicarbonate or carbonate byproduct formation. Here, as H₂ is a desired product to form syngas, reactor solutions utilize low pH (pH<7) to avoid fouling carbonate formation and encourage H₂ evolution.

The syngas creation system is scalable depending on design choice and design constrains and not limited by supply chain constraints or materials synthesis limitations. In an example, the syngas creation system can include a gas creation station, a crude creation station, and a crude refining station. The gas creation station can extract CO₂ from the atmosphere or other source such as flue gas and convert the extracted CO₂ into synthesis gas or syngas. More specifically, the syngas can be formed using co-electrocatalysts: H₂O+CO₂→H₂+CO+O₂ or the hydrogen and CO can be formed separately to be combined later: CH₄>2H₂+C(s) and CO₂→CO+½O₂. The gas creation station can include a reactor that includes a hydrogen electrode and an oxygen electrode as the cathode and anode. The energy for the syngas creation can be provided by a low-carbon energy source such as small modular reactor, geothermal, hydroelectric energy, solar energy, or wind energy. The created syngas can be sent to the crude creation station or some other station or facility where the syngas can be processed. For example, the syngas can be used for power generation, used to produce hydrogen, used to produce methanol, used to produce ethanol, used to produce kerosene, used to produce diesel, used to produce propane, and/or other uses for the syngas.

If the syngas is sent to a crude creation station, the crude creation station can use the syngas to create heavy synthetic crude oil (syncrude), methanol, or some other product or products that can be created from the syncrude by the crude creation station. For example, a Fischer-Tropsch synthesis reaction can be used to convert the syngas into syncrude. In some specific examples, one or more of iron, cobalt, ruthenium, thorium, nickel, copper, manganese, chromium, vanadium, titanium, molybdenum, niobium, zirconium, and other similar catalysts including, but not limited to, carbides, nitrides, oxides, phosphides, sulfides, arsenides, selenides, and tellurides of the foregoing metals may be used as the catalyst in the Fischer-Tropsch synthesis reaction.

The created heavy syncrude from the crude creation station can be sent to the crude refining station. The crude refining station can use the heavy syncrude to create synthetic fuel (e.g., propane, gasoline, kerosene, diesel) or other products (e.g., lubricants, waxes). The crude refining station can be a crude cracking station, a hydrotreating station, or some other type of process can be used to convert the heavy syncrude to synthetic fuel or some other product.

For example, the crude refining station can be a crude cracking station. More specifically, the crude cracking station can use a catalytic cracking process to convert the heavy syncrude into synthetic fuel. The catalytic cracking process involves the presence of, for example, solid acid catalysts. The solid acid catalyst can include silica-alumina, zeolites, ZSM-5, NiMo, MCM-41, NiMo/MCM-41, NiMo/ASA, NiMo/USY, metals (e.g., iron, cobalt, nickel, ruthenium, rhodium, palladium, osmium, iridium, and platinum, or a combination of molybdenum and tungsten), or some other type of catalysts that can help promote the formation of carbocations, which undergo processes of rearrangement and scission of C—C bonds, and convert the heavy syncrude to the synthetic fuel.

In another example, the crude refining station can be a hydrotreating station. More specifically, hydrotreating is a catalytic conversion process in petroleum refining, among others, for removing impurities such as nitrogen and sulfur compounds from hydrocarbon streams. During hydrotreating, crude oil cuts are selectively reacted with hydrogen in the presence of a catalyst at relatively high temperatures and moderate pressures. The process converts undesirable aromatics, olefins, nitrogen, metals, and organosulfur compounds into stabilized products. Some hydrotreated cuts may require additional processing to meet final product specifications. Each hydrotreating unit is tailored to the feedstock and end product. For example, the process to hydrotreat naphtha is not the same as the process for diesel fuels. The most common cuts that are hydrotreated in a refinery include: light naphtha, heavy naphtha, jet fuel or kerosene, and diesel oils (e.g., light, and heavy coker diesel oil). The feed is first pressurized and added to hydrogen streams. The mixture is heated to about 290-430° C. before entering a fixed-bed or other reactor, which operates at about 7-180 bar. Higher temperatures and pressures are used for processing heavier feedstocks, such as diesel oils. Overall, however, hydrotreater temperatures are relatively moderate to avoid thermal cracking of molecules while being high enough to enable reaction of the feedstock. Inside the fixed-bed reactor, hydrogenolysis and mild hydrocracking reactions take place to convert sulfur, nitrogen, oxygen, and other contaminants to hydrogen sulfide, ammonia, water vapor, and other stabilized byproducts. The catalyst used in the reactor is a crucial design consideration that greatly affects the final products. If sulfur removal is the primary goal, cobalt-molybdenum catalysts are favored. If the crude oil is relatively low in sulfur, nitrogen removal becomes the priority and nickel-molybdenum catalysts are chosen. Depending on the conditions and composition of the outlet streams, the byproducts are either discarded, recycled, or sent for further treatment.

The electrochemical reduction of carbon dioxide, also known as electrolysis of carbon dioxide, is the conversion of CO₂ to more reduced chemical species using electrical energy. As stated above, in the electrocatalysis system, such as the PV-ECs and the PVIEs, used to split water and reduce CO₂ can comprise four or five core components. More specifically, the electrocatalysis system can include an oxygen evolution reaction (OER) electrode (anode) with catalyst, a hydrogen/CO evolution reaction (HCER) electrode (cathode) with catalyst, electrolyte, reaction separating membrane, and, in the case of PVIEs, an integrated PV cell. On each side of the membrane, the reactor may further comprise gas diffusion electrodes (GDEs) or carbon paper to allow for gas diffusion within the reactor. GDEs typically are composed of carbon but may be any porous material that does not adversely affect the desired electrochemical reactions. The OER and HCER catalysts may be coated onto the GDEs, carbon paper, membrane, or a combination thereof. In some examples, a graphitic carbon nitride (g-C₃N₄) can be used as an HCER catalyst in an electrolyzer to form syngas. In some examples, metals, such as Cu, Ag, Au, Ni, Pd, Pt, Co, Rh, Ir, Fe, Ru, Os, or other Lewis acids may be used to modify the catalytic and/or electronic properties of the g-C₃N₄. For example, in a specific illustrative example, about one mole percent (1%) to about thirty mole percent (30%), and ranges therein (e.g., 9.5 mole percent, 10.25 mole percent, 10.75 mole percent, etc.), of Au or Ag may be embedded in the g-C₃N₄. In another specific illustrative example, about five mole percent (5%) to about fifteen mole percent (15%), and ranges therein (e.g., 9.5 mole percent, 10.25 mole percent, 10.75 mole percent, etc.), of Au or Ag may be embedded in the g-C₃N₄. In a specific example, about ten mole percent (10%) of Au or Ag may be embedded in the g-C₃N₄.

g-C₃N₄ is typically composed of tri-s-triazine units (heptazine) or s-triazine units linked by nitrogen atoms. Heptazine units consist of three fused six-membered rings, each containing three carbon and three nitrogen atoms. The typical form of g-C₃N₄ is a polymeric material with a repeating unit of C₆N₉H₃. g-C₃N₄ has a layered structure similar to graphite, but with nitrogen atoms incorporated into the carbon lattice forming phthalocyanine-like active and binding sites. The layers in g-C₃N₄ are held together by van der Waals forces, similar to the layers in graphite. This weak interlayer bonding allows for easy exfoliation into thinner sheets or even single layers, enhancing the surface area and catalytic activity. Thus, g-C₃N₄ is akin to graphene and represents a 2D material. The g-C₃N₄ structure has repeating Lewis basic sites (the phthalocyanine-like active and binding sites) where metals, such as Cu, Ag, Au, Ni, Pd, Pt, Co, Rh, Ir, Fe, Ru, Os, or other Lewis acids can bind to modify the catalytic and/or electronic properties of the material. These binding sites can be occupied fully or partially, by one or more metals or Lewis acids.

The g-C₃N₄ catalyst has relatively high thermal and chemical stability (as compared to some other catalysts) and can withstand electrochemical environments involving relatively strong acids, relatively strong bases, and relatively high temperatures. Also, the layered structure of the g-C₃N₄ catalyst can be engineered to have a relatively large surface area to enhance catalytic properties of the g-C₃N₄ catalyst. Further, the electronic properties of the g-C₃N₄ catalyst allow for relatively efficient separation of photo-generated electron-hole pairs, which is necessary for the efficiency of photocatalytic and photoelectrochemical processes. In addition, the electronic structure of the g-C₃N₄ catalyst can be tuned through doping with various elements or by creating composite materials with other semiconductor to allow for tunability and optimization of catalytic properties for specific electrolysis reactions. Also, the g-C₃N₄ catalyst is comprised of carbon and nitrogen which are earth-abundant elements and are considered non-toxic. This makes the g-C₃N₄ catalyst environmentally friendly for catalytic applications.

In a specific example, the mixed g-C₃N₄ and Cobalt (II) phthalocyanine (CoPc) may be used as an HCER catalyst and co-catalyst in an electrolyzer to form syngas. In some examples, the g-C₃N₄ and the CoPc catalyst may be embedded into a carbon nanotube (CNT) matrix for electrical conductivity. In some examples, if the CoPc catalyst is used, hydrogen reduction may be further promoted by addition of Pt. In some examples, A₂PtX₄ and A₂PtX₆, where A=H, Li, Na, K, Rb, Cs and X=F, Cl, Br, I, or some other similar compound or compounds can be used in addition to the platinic acid or as a replacement of the platinic acid for the Pt source. The Pt (or other similar compound or compounds) can be in very low concentrations (e.g., 0.0024 mg/cm²) and likely forms very small (single atom or small nanoparticle) active sites within the matrix for H₂ formation. It should be noted that the CNT matrix can be used for hydrogen reduction in other applications other than the ones discussed herein and may be used in any electrolyzer reactor type and/or any other reactions.

In all the electrocatalysis systems, the pH must be controlled. One way of controlling the pH is to use an aqueous mixture that includes a catholyte and/or an anolyte. The problem with using catholyte and/or anolyte to control the pH in current systems is that the catholyte and/or the anolyte have to be continually added to the system. Repeatedly adding catholyte and/or anolyte can be expensive and cumbersome.

In some of the electrocatalysis systems described herein, the pH of the system can be controlled using pressurized CO₂. The amount of CO₂ in electrolytes determines the pH and the most common source of acidity in electrolytes is dissolved CO₂. This is because when CO₂ is introduced into an electrolyte, a small portion of the CO₂ becomes carbonic acid (H₂CO₃) and the carbonic acid reduces the pH of the system (e.g., reduces the pH of the catholyte in the system). The reaction is as follows: CO_{2(ag)}+H₂O→H₂CO_{3(aq)}. Therefore, the more CO₂ in the electrolyte, the lower the pH. The electrocatalysis system can be driven using an electric source. For example, the electrocatalysis system may be driven using energy from a PV source, from an electric grid, nuclear power source, wind power source, geothermal power source, hydropower source, or some other type of source that can generate the energy needed to drive the electrocatalysis system.

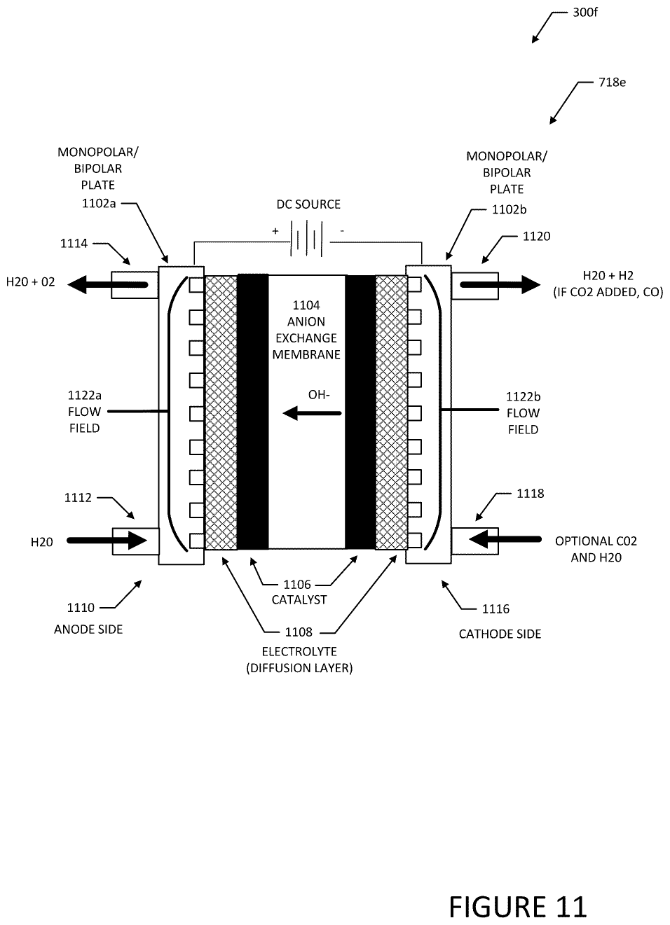

In the electrocatalysis system, when the reaction vessel is pressurized with CO₂, there are two different equilibria. One equilibria produces carbonic acid, as described above, and the other equilibria occurs when the pressure is increased past an equilibrium breakover point (illustrated in FIG. 12). Once the CO₂ is at a high enough pressure (e.g., past the equilibrium breakover point), the left side of the equation (CO_{2(aq)}+H₂O→H₂CO₃) becomes saturated meaning primarily just carbonic acid is present over CO₂. The carbonic acid is in equilibrium with a proton and bicarbonate. That is important because the pH reached under nominal pressure is 5 or 7. Once a significant enough pressure is reached (e.g., past the equilibrium breakover point), the right-hand side of the equation (H₂CO₃→H⁺_{(aq)}+HCO₃⁻_{(aq)}) is dominate and the solution will have a low enough pH to run the reaction for syngas production without adding external additional catholyte and/or additional anolyte or any external electrolyte or acid. When CO₂ is added at or past the past equilibrium breakover point, the reaction in the system causes a bicarbonate, which is the electrolyte, to form and a proton (CO₂+H₂O) that acts as the acid. The reaction is continuously replenished without having to add the electrolyte, acid, or any external additional catholyte and/or additional anolyte and helps to cut two portions of the cost of running the system.

The electrolytes in the reaction vessel of the electrocatalysis system comprise conductive media utilized for charge transport in some electrolyzers. In some embodiments, a catholyte and anolyte may be used and the catholyte can be the same constitution as the anolyte. In other embodiments, the catholyte may be different in constitution than the anolyte. In some embodiments, the catholyte and anolyte collectively comprise the electrolyte. Membranes in the reaction vessel of the electrocatalysis system compromise materials that separate cathodic and anodic reactions in some electrolyzers. The membranes may be continuous, some may be porous, some may be mesoporous, some may be nanoporous, some may be microporous, some may be charge selective, some may be ion selective, some may be inorganic, and some may be organic.

The catholytes may be present in alkaline electrolyzers (AE), proton exchange membrane electrolyzers, anion exchange membrane (AEM) electrolyzers, solid oxide electrolyzers (SOE), molten carbonate electrolyzers (MCE), or some other type of reaction vessel of the electrocatalysis system. The alkaline electrolyte can be a potassium hydroxide (KOH) solution and are the most commonly used catholyte in alkaline electrolyzers. Potassium hydroxide electrolytes provide good ionic conductivity and enable efficient electrolysis at relatively low temperatures. Other examples of alkaline electrolytes can include, NaOH, LiOH, K₂CO₃, Na₂CO₃, NH₄OH.

The proton exchange membrane electrolytes can be perfluorosulfonic acid (PFSA) membranes. The PFSA membranes act as solid electrolyte and do not require a liquid catholyte. They provide proton conduction between the anode and cathode compartments, facilitating the generation of hydrogen gas at the cathode.

The solid oxide electrolyzers (SOE) operate at high temperatures and employ solid oxide materials as catholyte. These materials have oxygen-ion conducting properties, allowing the transport of oxygen ions from the cathode to the anode. The molten carbonate electrolyzers (MCE) use high-temperature molten carbonate salts as catholyte. Typically, a mixture of lithium carbonate (Li₂CO₃) and potassium carbonate (K₂CO₃) is used.

The anolytes can be present in alkaline electrolyzers, proton exchange membrane electrolyzers, solid oxide electrolyzers, molten carbonate electrolyzers, or some other type of reaction vessel of the electrocatalysis system. The alkaline electrolytes can be a potassium hydroxide solution. The potassium hydroxide is commonly used as both catholyte and anolyte in alkaline electrolytes. The potassium hydroxide solution provides good ionic conductivity and enables efficient electrolysis at relatively low temperatures. Other examples of alkaline electrolytes include, NaOH, LiOH, K₂CO₃, Na₂CO₃, NH₄OH.

The proton exchange membrane electrolytes can include dilute sulfuric acid (H₂SO₄), Phosphoric Acid (H₃PO₄), or electrolytes of ionic salts. Dilute sulfuric acid is commonly used as an electrolyte in proton exchange membrane electrolyzers. Dilute sulfuric acid provides a source of protons (H⁺) for the electrochemical reaction occurring at the anode, allowing for the production of hydrogen gas. Phosphoric acid can also be used as an electrolyte in proton exchange membrane electrolyzers. The dilute sulfuric acid facilitates the dissociation of water molecules, generating protons (H⁺) and promoting the electrochemical reactions at the anode and cathode. In an anion exchange membrane, alkaline electrolytes, such as potassium hydroxide (KOH) or sodium hydroxide (NaOH) solutions, may be used. These alkaline solutions provide hydroxide ions (OH⁻) for the electrochemical reaction at the anode, enabling the production of hydrogen gas. Exchange membranes can also utilize electrolytes of specific ionic salts, such as ammonium formate (NH₄HCO₂) or ammonium bicarbonate (NH₄HCO₃). These solutions act as electrolytes, providing protons (H⁺) or hydroxide ions (OH) for the respective electrochemical reactions at the cathode or anode.

Solid oxide electrolyzers operate at high temperatures and employ solid oxide materials as both catholyte and anolyte. These materials have oxygen-ion conducting properties, allowing the transport of oxygen ions between the anode and cathode. Molten salt electrolyzers utilize high-temperature molten salts as the anolyte. Commonly used molten salts include sodium chloride (NaCl) or potassium chloride (KCl).

Flow reactor electrolyzers utilize separate compartments for the anode and cathode, allowing for the use of different electrolyte solutions such as catholytes and anolytes. Some catholytes and anolytes used in flow electrolyzers include electrolytes, organic electrolytes, non-aqueous organic electrolytes, ionic liquids, redox couples, and other electrolyte solutions.

Electrolytes can include acidic solutions and alkaline solutions. The acidic solutions can include dilute sulfuric acid (H₂SO₄) or phosphoric acid (H₃PO₄) solutions to be used as catholytes in flow electrolyzers, providing the necessary protons (H⁺) for the cathodic reactions. The alkaline solutions can include KOH or NaOH solutions to be used as catholytes, offering high ionic conductivity, and facilitating the electrochemical reactions at the cathode.

Organic electrolytes include aqueous organic electrolytes. For example, organic solvents, such as acetonitrile (CH₃CN), mixed with supporting electrolytes like tetrabutylammonium tetrafluoroborate (TBABF₄), can serve as catholytes and anolytes in flow electrolyzers. These organic electrolytes provide different redox couples and can enable specific electrochemical reactions.

Non-aqueous organic electrolytes such as propylene carbonate (PC), dimethyl sulfoxide (DMSO), or acetonitrile, combined with appropriate supporting salts, can be used as catholytes and anolytes to enable specific electrochemical reactions in flow electrolyzers. For example, tetraalkylammonium salts, such as tetraethylammonium tetrafluoroborate (TEABF₄) or tetraethylammonium hexafluorophosphate (TEAPF₆), are commonly used in organic electrolytes for flow reactor electrolyzers. These salts provide the necessary ions for conducting electrochemical reactions. Other alkyl groups can be used, such as methyl, propyl and butyl, and their isomers. Also, various lithium salts, such as lithium hexafluorophosphate (LiPF₆) or lithium bis(trifluoromethanesulfonyl)imide (LiTFSI), can be used as electrolyte salts in organic electrolytes. These salts dissociate into lithium cations (Li⁺) and corresponding anions, providing ionic conductivity. Sodium salts, including sodium tetrafluoroborate (NaBF₄) or sodium hexafluorophosphate (NaPF₆), can be used as electrolyte salts in organic electrolytes for flow reactor electrolyzers. These salts dissociate into sodium cations (Na⁺) and corresponding anions, facilitating ionic transport. Potassium salts, such as potassium tetrafluoroborate (KBF₄) or potassium hexafluorophosphate (KPF₆), can be employed as electrolyte salts in organic electrolytes. These salts dissociate into potassium cations (K₊) and corresponding anions, allowing for ionic conduction. Imidazolium salts, such as 1-butyl-3-methylimidazolium bromide ([BMIM]Br) or 1-ethyl-3-methylimidazolium tetrafluoroborate ([EMIM]BF₄), can be employed as catholyte and anolyte salts in organic electrolytes. These salts dissociate into imidazolium cations and corresponding anions, facilitating the electrochemical reactions at the electrode. Pyridinium salts, such as N-butylpyridinium bromide or N-butylpyridinium tetrafluoroborate, can be used as catholyte and anolyte salts in flow reactor electrolyzers. These salts dissociate into pyridinium cations and corresponding anions, allowing for the necessary ionic transport at the cathode. Phosphonium salts, such as trihexyl(tetradecyl)phosphonium chloride or tributyl(tetradecyl)phosphonium tetrafluoroborate, can be used as catholyte and anolyte salts in flow reactor electrolyzers. These salts dissociate into phosphonium cations and corresponding anions, allowing for the necessary ionic transport at the cathode.

Ionic liquids are molten salts that are liquid at or near room temperature. The molten salts can be used as catholytes and anolytes in flow electrolyzers due to their low volatility and wide electrochemical stability window. Examples of ionic liquids used as electrolytes include imidazolium-based or pyridinium-based salts. For example, 1-Ethyl-3-methylimidazolium bis(trifluoromethylsulfonyl)imide ([EMIM][TFSI]) is one of the most commonly used ionic liquids in electrochemical applications. [EMIM][TFSI] exhibits a wide electrochemical stability window, good ionic conductivity, and thermal stability. 1-Ethyl-3-methylimidazolium bis(trifluoromethylsulfonyl)imide is suitable for various electrochemical processes, including batteries, capacitors, and electrochemical synthesis. N-Methyl-N-propylpyrrolidinium bis(trifluoromethylsulfonyl)imide ([MPPYR][TFSI]) is another ionic liquid that can be used in electrochemical systems. [MPPYR][TFSI] offers good electrochemical stability, low volatility, and high ionic conductivity. N-Methyl-N-propylpyrrolidinium bis(trifluoromethylsulfonyl)imide is used in batteries, supercapacitors, and other electrochemical devices. 1-Butyl-3-methylimidazolium tetrafluoroborate ([BMIM][BF₄]) is a widely studied ionic liquid with good electrochemical stability, low melting point, and relatively high conductivity. [BMIM][BF₄] has been employed in various electrochemical applications, including fuel cells, solar cells, and electroplating. 1-Octyl-3-methylimidazolium hexafluorophosphate ([OMIM][PF₆]) is an ionic liquid known for its high thermal stability and low volatility. [OMIM][PF₆] exhibits good ionic conductivity and has been utilized in electrochemical systems, such as batteries, supercapacitors, and catalysis. Choline-based ionic liquids, such as choline chloride ([Ch][Cl]) or choline dihydrogen phosphate ([Ch][DHP]), have relatively low toxicity and relatively low cost as compared to other ionic liquids. Choline-based ionic liquids have favorable properties for various electrochemical applications, including electrolytes in batteries, supercapacitors, and electrochemical sensors. Various imidazolium-based ionic liquids, such as 1-butyl-3-methylimidazolium chloride ([BMIM][Cl]) or 1-ethyl-3-methylimidazolium acetate ([EMIM][OAc]), can be used as electrolytes in different electrochemical systems. These ionic liquids exhibit good electrochemical stability and ionic conductivity.

Redox couples such as ferrocyanide/ferricyanide or bromide/bromine, can be used as catholytes and anolytes in flow reactor electrolyzers. These redox couples undergo reversible redox reactions at the electrode, enabling the storage or conversion of electrical energy.

The membrane used in the in the reaction vessel of the electrocatalysis system can include a proton exchange membrane, anion exchange membrane, solid oxide electrolyte membrane, bipolar membrane, ceramic membrane, or some other type of membrane that can help facilitate the reactions in the reaction vessel of the electrocatalysis system.

The proton exchange membrane, also known as polymer electrolyte membranes, are widely used in proton exchange membrane electrolyzers. These membranes are typically made of perfluorosulfonic acid (PFSA) materials, such as Nafion™, which exhibit high proton conductivity and excellent chemical stability. More specifically, Nafion™ is one of the most widely known and commonly used proton exchange membranes. Nafion™ is a perfluorosulfonic acid (PFSA) polymer developed by DuPont™. Nafion™ membranes exhibit high proton conductivity, excellent chemical stability, and good mechanical properties, making them suitable for applications such as fuel cells, electrolyzers, and redox flow batteries. Aquivion™ is a PFSA-based proton exchange membrane developed by Solvay™. Similar to Nafion™, Aquivion™ membranes offer high proton conductivity and chemical stability. Aquivion™ membranes are used in various electrochemical devices, including fuel cells, electrolyzers, and electrochemical sensors. Fumatech™ and Fumapem™ are a series of PFSA-based proton exchange membranes. These membranes provide high proton conductivity, good chemical resistance, and mechanical strength. Fumatech™ and Fumapem™ are used in applications such as fuel cells, electrolyzers, and electrochemical reactors. Flemion™ is a perfluorocarbon sulfonic acid polymer developed by Asahi Glass Company™. Flemion™ is a PFSA-based proton exchange membrane that exhibits high proton conductivity and good chemical stability. Flemion™ membranes are utilized in fuel cells, water electrolysis, and other electrochemical systems. Xtreme™ is a range of PFSA-based proton exchange membranes developed by Dow DuPont™. These membranes offer high proton conductivity, good chemical resistance, and thermal stability. Xtreme™ membranes are used in various applications, including fuel cells and electrolyzers. Gore-Select™ membranes are a PFSA-based proton exchange membrane manufactured by W. L. Gore & Associates™. These membranes provide high proton conductivity and chemical durability. Gore-Select™ membranes are used in fuel cells, electrolyzers, and other electrochemical systems.

The anion exchange membranes are used in anion exchange membrane electrolyzers. These membranes facilitate the transport of hydroxide ions (OH−) from the cathode to the anode compartment. Anion exchange membranes are often made of quaternary ammonium functionalized polymers, such as quaternized poly(vinylbenzyl chloride) or quaternized poly(phenylene oxide). For example, Tokuyama A201™ is a commercially available anion exchange membrane widely used in alkaline fuel cells and alkaline water electrolysis. It is made from quaternized poly (2,6-dimethyl-1,4-phenylene oxide) and offers good hydroxide ion conductivity and chemical stability. FAA-3™ is an anion exchange membrane developed by FuMA-Tech GmbH™. FAA-3™ is a quaternary ammonium-functionalized poly(phenylene oxide) membrane used in various electrochemical devices, including alkaline fuel cells and water electrolyzers. IonPower A201™ is an anion exchange membrane manufactured by Tianjin Shengquan New Technology Co., Ltd™. IonPower A201™ is a quaternary ammonium-functionalized poly(phenylene oxide) membrane suitable for applications in alkaline fuel cells, electrolyzers, and redox flow batteries. FAP-450™ is an anion exchange membrane produced by FuMA-Tech GmbH™. FAP-450™ is a poly(arylene ether) membrane functionalized with quaternary ammonium groups. FAP-450™ is used in various electrochemical systems, including alkaline fuel cells and electrolyzers. Umem™ is an anion exchange membrane developed by the National Institute of Advanced Industrial Science and Technology (AIST) in Japan. Umem™ is composed of a poly(arylene ether) matrix functionalized with quaternary ammonium groups. Umem™ is utilized in alkaline fuel cells, alkaline water electrolyzers, and other electrochemical devices. AMX™ is a series of anion exchange membranes developed by Dow Dupont™. These membranes are made of quaternary ammonium-functionalized poly(phenylene oxide) or poly(arylene ether) materials. AMX™ membranes are used in alkaline fuel cells, water electrolysis, and other electrochemical systems.

The solid oxide electrolyte membranes are employed in solid oxide electrolyzers. Solid oxide electrolyte membranes are typically made of oxygen-ion conducting ceramics, such as yttria-stabilized zirconia (YSZ) or doped ceria materials. Solid oxide electrolyte membranes allow the transport of oxygen ions (O²⁻) from the cathode to the anode. Yttria-stabilized zirconia is one of the most widely used solid oxide electrolytes and is composed of zirconium dioxide (ZrO₂) doped with yttrium oxide (Y₂O₃). Yttria-stabilized zirconia exhibits high oxygen-ion conductivity at elevated temperatures, typically above 600 degrees Celsius. Yttria-stabilized zirconia is used in solid oxide fuel cells (SOFCs), SOEs, and other high-temperature electrochemical devices. Gadolinium-doped ceria is a solid oxide electrolyte based on cerium dioxide (CeO₂) doped with gadolinium oxide (Gd₂O₃). Gadolinium-doped ceria demonstrates high oxygen-ion conductivity even at lower temperatures, making it suitable for intermediate-temperature solid oxide fuel cells (IT-SOFCs) and other electrochemical devices. Scandia-stabilized zirconia is similar to yttria-stabilized zirconia but doped with scandium oxide (Sc₂O₃) instead of yttrium oxide. Scandia-stabilized zirconia exhibits enhanced oxygen-ion conductivity and mechanical stability at high temperatures. Scandia-stabilized zirconia is used in high-temperature electrochemical devices, such as SOFCs and oxygen separation membranes. Lanthanum gallate is a solid oxide electrolyte material with the chemical formula La_{0.9}Sr_{0.1}Ga_{0.8}Mg_{0.2}O_{3-δ} (LSGM). Lanthanum gallate offers high oxide-ion conductivity at intermediate temperatures and is commonly employed in intermediate-temperature solid oxide fuel cells, oxygen separation membranes, and other electrochemical applications. Various perovskite oxides exhibit solid oxide electrolyte properties, such as strontium-doped lanthanum manganite (LSM) and lanthanum cobaltite (LSC). These materials possess mixed ionic-electronic conductivity, making them suitable as solid oxide electrolytes in certain electrochemical systems. Cerium Oxide-Based Electrolytes, Cerium oxide (CeO₂) and its doped derivatives, such as samaria-doped ceria (SDC) or gadolinium-doped ceria (GDC), are used as solid oxide electrolytes in some electrochemical applications. These materials offer oxygen-ion conductivity and find utility in SOFCs and other high-temperature devices.

The bipolar membranes are composed of an anion exchange layer and a cation exchange layer. Bipolar membranes are used in water electrolyzers, such as alkaline electrolyzers, to separate the anode and cathode compartments. Bipolar membranes enable the selective transport of hydroxide ions (OH) towards the anode and hydrogen ions (H⁺) towards the cathode. For example, Zirfon™ bipolar membrane is a commercially available bipolar membrane designed for applications such as water splitting, electrochemical synthesis, and electrodialysis. Zirfon™ bipolar membrane consists of a cation exchange layer, an anion exchange layer, and a selective barrier layer in between. FAB-BCT bipolar membrane is a bipolar membrane developed by FuMA-Tech GmbH™. It is used in various electrochemical processes, including water splitting, electrodialysis, and electrosynthesis. The FAB-BC™ bipolar membrane features a combination of cation exchange and anion exchange functionalities.

The ceramic membranes, such as porous ceramic materials or mixed ionic-electronic conductors, can be used in high-temperature electrolyzers. These membranes offer high stability and allow for the transport of specific ions based on their conductivity properties. For example, perovskite ceramic membranes include perovskite materials, such as strontium-doped lanthanum manganite (LSM) or lanthanum strontium cobalt ferrite (LSCF). The perovskite materials can be used as a ceramic membrane in high-temperature electrolyzers and exhibit mixed ionic-electronic conductivity, enabling the transport of oxygen ions during electrolysis processes. Stabilized zirconia membranes, particularly yttria-stabilized zirconia or scandia-stabilized zirconia are commonly used in high-temperature electrolyzers. These materials offer high oxygen-ion conductivity at elevated temperatures, allowing for efficient electrolysis operations. Silica-based membranes, such as mesoporous silica membranes or silica-based mixed matrix membranes, offer high selectivity and can be tailored for specific separation requirements in electrolysis processes. Mixed ionic-electronic conducting membranes, which possess both ionic and electronic conductivity, are used in certain electrolyzer configurations. Examples of mixed ionic-electronic conducting membranes include perovskite-based materials, such as lanthanum strontium cobaltite (LSC), which enable oxygen-ion transport while also conducting electrons. Permeable ceramic supports include ceramic materials, such as alumina (Al₂O₃) or silicon carbide (SiC). Permeable ceramic supports are often used as porous supports for ceramic membranes in electrolyzers. These permeable ceramic supports provide structural integrity and mechanical stability while allowing for gas diffusion and electrolyte transport.

In the following description, various aspects of the illustrative implementations will be described using terms commonly employed by those skilled in the art to convey the substance of their work to others skilled in the art. However, it will be apparent to those skilled in the art that the embodiments disclosed herein may be practiced with only some of the described aspects. For purposes of explanation, specific numbers, materials, and configurations are set forth in order to provide a thorough understanding of the illustrative implementations. However, it will be apparent to one skilled in the art that the embodiments disclosed herein may be practiced without the specific details. In other instances, well-known features are omitted or simplified in order not to obscure the illustrative implementations.

In the following detailed description, reference is made to the accompanying drawings that form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). Reference to “one embodiment” or “an embodiment” in the present disclosure means that a particular feature, structure, or characteristic described in connection with the embodiment is included in at least one embodiment. The appearances of the phrase “in one embodiment” or “in an embodiment” are not necessarily all referring to the same embodiment. The appearances of the phrase “for example,” “in an example,” or “in some examples” are not necessarily all referring to the same example. The term “about” includes a plus or minus twenty percent (±20%) variation. For example, about one (1) millimeter (mm) would include one (1) mm and ±0.2 mm from one (1) mm. Similarly, terms indicating orientation of various elements, for example, “coplanar,” “perpendicular,” “orthogonal,” “parallel,” or any other angle between the elements generally refer to being within plus or minus five to twenty percent (+/−5-20%) of a target value based on the context of a particular value as described herein or as known in the art.

As used herein, the term “when” may be used to indicate the temporal nature of an event. For example, the phrase “event ‘A’ occurs when event ‘B’ occurs” is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur. Reference to “one example” or “an example” in the present disclosure means that a particular feature, structure, or characteristic described in connection with the embodiment is included in at least one example or embodiment. The appearances of the phrase “in one example” or “in an example” are not necessarily all referring to the same examples or embodiments.

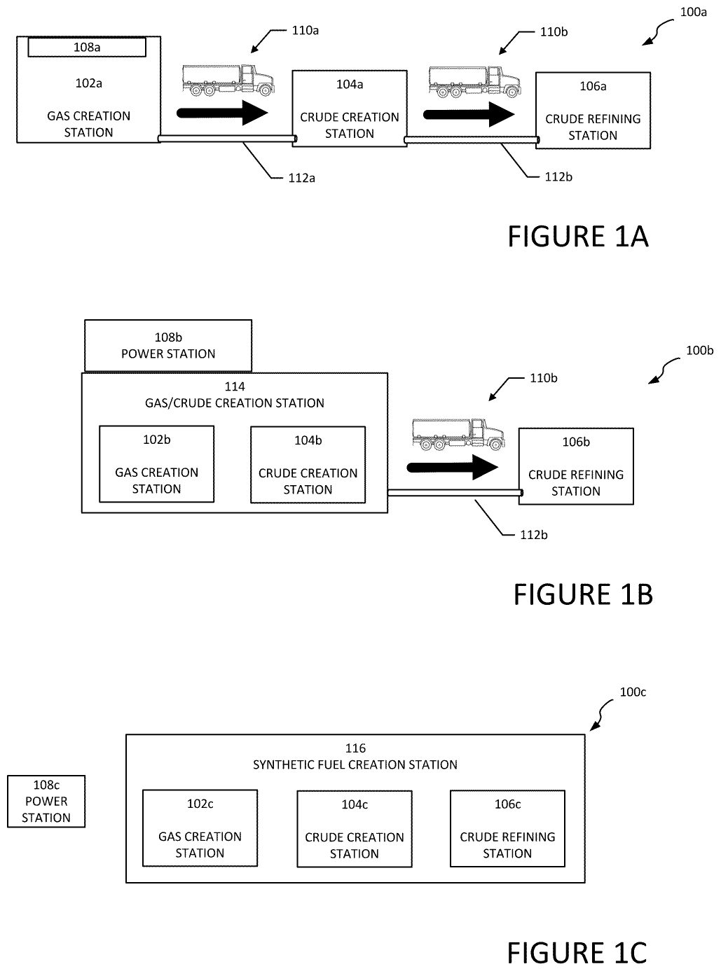

FIG. 1A is simplified block diagram of a particular non-limiting implementation of a synthetic fuel creation system 100, in accordance with an embodiment of the present disclosure. In some examples, the synthetic fuel creation system 100a can include a gas creation station 102a, a crude creation station 104a, and a crude refining station 106a. A power station 108a can help provide power to the gas creation station 102a. In some examples, the power station 108a is a renewable energy power station. For example, the power station 108a may be one or more solar cells (e.g., an array of solar cells), one or more wind turbines or windmills (e.g., a wind farm), or some other type of renewable energy power station. In some examples, the power station 108a is part of a PV-integrated electrocatalysis system.

The gas creation station 102a can create synthesis gas or syngas. In an example, the gas creation station 102a can use pressurized carbon dioxide (CO₂) to help control the pH of the system. In a specific example, g-C₃N₄ can be used as an HCER catalyst in an electrolyzer to form syngas. In some examples, metals, such as Cu, Ag, Au, Ni, Pd, Pt, Co, Rh, Ir, Fe, Ru, Os, or other Lewis acids may be used to modify the catalytic and/or electronic properties of the g-C₃N₄. For example, in a specific illustrative example, about one mole percent (1%) to about thirty mole percent (30%), and ranges therein (e.g., 9.5 mole percent, 10.25 mole percent, 10.75 mole percent, etc.), of Au or Ag may be embedded in the g-C₃N₄. In another specific illustrative example, about five mole percent (5%) to about fifteen mole percent (15%), and ranges therein (e.g., 9.5 mole percent, 10.25 mole percent, 10.75 mole percent, etc.), of Au or Ag may be embedded in the g-C₃N₄. In a specific example, about ten mole percent (10%) of Au or Ag may be embedded in the g-C₃N₄. In another specific example, g-C₃N₄ and/or a CoPc catalyst embedded into a CNT matrix can be used as a catalyst in an electrolyzer to form syngas. In some examples, hydrogen reduction is further promoted by addition of Pt in very low concentrations (e.g., about 0.0024 mg/cm²). The syngas produced from the gas creation station 102a can be sent to the crude creation station 104a using a mobile transport 110a, a direct pipeline 112a, or some other means. The mobile transport 110a may be a tanker truck, tanker train, or some other mobile transport.

The crude creation station 104a can create heavy syncrude. The heavy syncrude produced from the crude creation station 104a can be sent to the crude refining station 106a using a mobile transport 110b, a direct pipeline 112b, or some other means. The mobile transport 110b may be a tanker truck, tanker train, or some other mobile transport.

The crude refining station 106a can convert the heavy syncrude into one or more synthetic fuels. The synthetic fuels produced from the crude refining station 106a can be used as a replacement for fossil-based fuels.

Turning to FIG. 1B, FIG. 1B is simplified block diagram of a particular non-limiting implementation of a synthetic fuel creation system 100b, in accordance with an embodiment of the present disclosure. In some examples, the synthetic fuel creation system 100b can include a gas/crude creation station 114 and a crude refining station 106b. The gas/crude creation station 114 can include a gas creation station 102b and the crude creation station 104b. A power station 108b can help provide power to the gas/crude creation station 114. In some examples, the power station 108b is a renewable energy power station. For example, the power station 108b may be one or more solar cells (e.g., an array of solar cells), one or more wind turbines or windmills (e.g., a wind farm), or some other type of renewable energy power station. In some examples, the power station 108b is part of a PV-integrated electrocatalysis system.

The gas creation station 102b can create synthesis gas or syngas. In an example, the gas creation station 102a can use pressurized CO₂ to help control the pH of the system. In a specific example, g-C₃N₄ can be used as an HCER catalyst in an electrolyzer to form syngas. In some examples, metals, such as Cu, Ag, Au, Ni, Pd, Pt, Co, Rh, Ir, Fe, Ru, Os, or other Lewis acids may be used to modify the catalytic and/or electronic properties of the g-C₃N₄. For example, between about nine mole percent (1%) to about eleven mole percent (30%) of Au or Ag or some other metal (e.g., Cu, Ni, Pd, Pt, Co, Rh, Ir, Fe, Ru, Os, or other Lewis acids) may be embedded in the g-C₃N₄. In another specific example, g-C₃N₄ and/or a CoPc catalyst embedded into a CNT matrix can be used as a catalyst in an electrolyzer to form syngas. In some examples, hydrogen reduction is further promoted by addition of Pt in very low concentrations (e.g., about 0.0024 mg/cm²). The syngas produced from the gas creation station 102b can be sent to the crude creation station 104b. The crude creation station 104b can create heavy syncrude. The heavy syncrude produced from the crude creation station 104b can be sent to the crude refining station 106b using the mobile transport 110b, the direct pipeline 112b, or some other means. The mobile transport 110b may be a tanker truck, tanker train, or some other mobile transport. The crude refining station 106b can convert the heavy syncrude into one or more synthetic fuels. The synthetic fuels produced from the crude refining station 106b can be used as a replacement for fossil-based fuels.

Turning to FIG. 1C, FIG. 1C is simplified block diagram of a particular non-limiting implementation of a synthetic fuel creation system 100c, in accordance with an embodiment of the present disclosure. In some examples, the synthetic fuel creation system 100c can include a synthetic fuel creation station 116. The synthetic fuel creation station 116 can include a gas creation station 102c, a crude creation station 104c, and a crude refining station 106c. A power station 108c can help provide power to the synthetic fuel creation station 116. In some examples, the power station 108c is a renewable energy power station. For example, the power station 108c may be one or more solar cells (e.g., an array of solar cells), one or more wind turbines or windmills (e.g., a wind farm), or some other type of renewable energy power station. In some examples, the power station 108c is part of a PV-integrated electrocatalysis system.

The gas creation station 102c can create synthesis gas or syngas. In an example, the gas creation station 102a can use pressurized CO₂ to help control the pH of the system. In a specific example, g-C₃N₄ can be used as an HCER catalyst in an electrolyzer to form syngas. In some examples, metals, such as Cu, Ag, Au, Ni, Pd, Pt, Co, Rh, Ir, Fe, Ru, Os, or other Lewis acids may be used to modify the catalytic and/or electronic properties of the g-C₃N₄. For example, in a specific illustrative example, about one mole percent (1%) to about thirty mole percent (30%), and ranges therein (e.g., 9.5 mole percent, 10.25 mole percent, 10.75 mole percent, etc.), of Au or Ag may be embedded in the g-C₃N₄. In another specific illustrative example, about five mole percent (5%) to about fifteen mole percent (15%), and ranges therein (e.g., 9.5 mole percent, 10.25 mole percent, 10.75 mole percent, etc.), of Au or Ag may be embedded in the g-C₃N₄. In a specific example, about ten mole percent (10%) of Au or Ag or some other metal (e.g., Cu, Ni, Pd, Pt, Co, Rh, Ir, Fe, Ru, Os, or other Lewis acids) may be embedded in the g-C₃N₄. In another specific example, g-C₃N₄ and/or a CoPc catalyst embedded into a CNT matrix can be used as a catalyst in an electrolyzer to form syngas. In some examples, hydrogen reduction is further promoted by addition of Pt in very low concentrations (e.g., about 0.0024 mg/cm²). The syngas produced from the gas creation station 102c can be sent to the crude creation station 104c. The crude creation station 104c can create heavy syncrude. The heavy syncrude produced from the crude creation station 104c can be sent to the crude refining station 106c. The crude refining station 106c can convert the heavy syncrude into one or more synthetic fuels. The synthetic fuels produced from the crude refining station 106c can be used as a replacement for fossil-based fuels.

Referring to FIGS. 1A-1C, in some examples, the syngas can be formed using co-electrocatalysts:

H₂O+CO₂→H₂+CO+O₂

In other examples, the hydrogen and CO can be formed separately to be combined later:
CH₄→2H₂+C(s) and CO₂→CO+½O₂.

The energy for the syngas creation can be provided by the power station 108. The created syngas can be sent to the crude creation station 104. The crude creation station 104 can use the syngas to create heavy syncrude or methanol (e.g., as fuel, a precursor for simple methylamines, methyl halides, and methyl ethers, etc.). In an example, a Fischer-Tropsch synthesis reaction can be used to covert the syngas into the heavy syncrude. In some specific examples, one or more of iron, cobalt, ruthenium, thorium, nickel, copper, manganese, chromium, vanadium, titanium, molybdenum, niobium, zirconium, and other similar catalysts including, but not limited to, carbides, nitrides, oxides, phosphides, sulfides, arsenides, selenides, tellurides of the foregoing metals may be used as the catalyst in the Fischer-Tropsch synthesis reaction.

The Fischer-Tropsch process is a catalytic chemical reaction in which carbon monoxide (CO) and hydrogen (H₂) in the syngas are converted into hydrocarbons of various molecular weights according to the equation:

(2n+1)H₂+nCO→CₙH₍₂ₙ₊₂₎+nH₂O

Where n is an integer. Thus, for n=1, the reaction represents the formation of methane, which in most CTL or GTL applications is considered an undesirable byproduct. The Fischer-Tropsch process conditions are usually chosen to maximize the formation of higher molecular weight hydrocarbon liquid fuels which are higher value products. There are other side reactions taking place in the process, among which the water-gas-shift reaction (CO+H₂O→H₂+CO₂) is predominant.

Depending on the catalyst, temperature, and type of process employed, hydrocarbons ranging from methane to higher molecular paraffins and olefins can be obtained. Small amounts of low molecular weight oxygenates (e.g., alcohol and organic acids) are also formed. The Fischer-Tropsch synthesis reaction is a condensation polymerization reaction of CO. and the products of the Fischer-Tropsch synthesis reaction obey a well-defined molecular weight distribution according to a relationship known as an Anderson-Shultz-Flory distribution.

The Anderson-Schulz-Flory distribution can be expressed as Wₙ/n=(1−α)²αⁿ⁻¹ where Wₙ is the weight fraction of hydrocarbons containing “n” carbon atoms, and “a” is the chain growth probability or the probability that a molecule will continue reacting to form a longer chain. In general, a is largely determined by the catalyst and the specific process conditions. The equation reveals that methane will always be the largest single product when “a” is less than 0.5, however, by increasing “α” close to one, the total amount of methane formed can be minimized compared to the sum of all of the various long-chained products. Increasing “a” increases the formation of long-chained hydrocarbons.

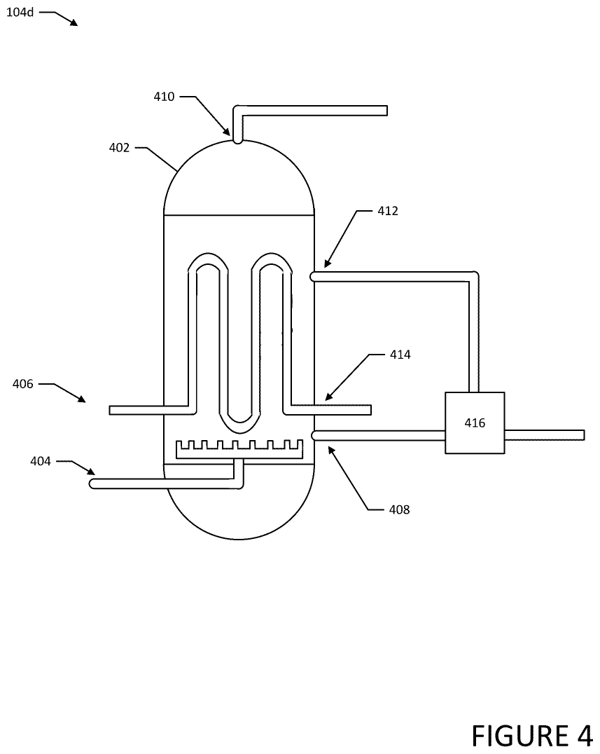

The created heavy syncrude from the crude creation station 104 can be sent to the crude refining station 106. The crude refining station 106 can use the heavy syncrude to create synthetic fuel. In some examples, distillation is used to separate the syncrude into different cuts (e.g., diesel, kerosene, gasoline, etc. as illustrated in FIG. 5). Anything heavier than diesel could then be cracked into lighter fuels and heavy fractions (e.g., diesel), can be cracked into lighter fuels, e.g., kerosene, if this were desired. More specifically, the crude refining station 106 can use a catalytic cracking process to convert the heavy syncrude into synthetic fuel. The catalytic cracking process involves the presence of solid acid catalysts. The solid acid catalyst can include silica-alumina, zeolites, ZSM-5, NiMo, MCM-41, NiMo/MCM-41, NiMo/ASA, NiMo/USY, metals (e.g., iron, cobalt, nickel, ruthenium, rhodium, palladium, osmium, iridium, and platinum, or a combination of molybdenum and tungsten), or some other type of catalysts that can help promote the formation of carbocations, which undergo processes of rearrangement and scission of C—C bonds, and convert the heavy syncrude to the synthetic fuel.

More specifically, cracking in the crude refining station 106 takes place using an active solid acid-based catalyst in a short-contact time vertical or upward-sloped pipe called a riser. Pre-heated feed is sprayed into the base of the riser via feed nozzles where it contacts extremely hot fluidized catalyst at about 1,230 to about 1,400° F. (about 666 to about 760 C). The hot catalyst vaporizes the feed and catalyzes the cracking reactions that break down the high-molecular weight synthetic crude oil into lighter components including synthetic propane, synthetic gasoline, synthetic diesel, and synthetic jet fuel. The catalyst-hydrocarbon mixture flows upward through the riser for a few seconds, and then the mixture is separated via cyclones. The catalyst-free hydrocarbons are routed to a main fractionator for separation into fuel gas, LPG, gasoline, naphtha, light cycle oils used in diesel and jet fuel, and heavy fuel oil.

During the trip up the riser, the cracking catalyst is “spent” by reactions which deposit coke on the catalyst and greatly reduce activity and selectivity. The “spent” catalyst is disengaged from the cracked hydrocarbon vapors and sent to a stripper where it contacts steam to remove hydrocarbons remaining in the catalyst pores. The “spent” catalyst then flows into a fluidized-bed regenerator where air (or in some cases air plus oxygen) is used to burn off the coke to restore catalyst activity and also provide the necessary heat for the next reaction cycle, cracking being an endothermic reaction. The “regenerated” catalyst then flows to the base of the riser, repeating the cycle.

The catalyst has four major components that include a solid acid catalyst, a matrix, a binder, and a filler. The solid acid catalyst can include ZSM-5, NiMo, MCM-41, NiMo/MCM-41, NiMo/ASA, NiMo/USY, metals (e.g., iron, cobalt, nickel, ruthenium, rhodium, palladium, osmium, iridium, and platinum, or a combination of molybdenum and tungsten), or some other type of catalyst that can help promote the formation of carbocations and convert the heavy syncrude to the synthetic fuel. The solid acid catalyst is the active component of the catalyst and can comprise from about 15% to 50%, by weight, of the catalyst. The solid acid catalysts can be a strong solid acid (equivalent to about 90% sulfuric acid). The matrix component can be an alumina matrix and also contributes to catalytic activity sites. The matrix component can include silica, MgO, CaO, scandium oxide, titanium oxide, vanadium oxide, chromium oxide, manganese oxide, iron oxide, zirconia, niobia, molybdenum oxide, hafnium oxide, titaniates, zirconates, plumbates, niobates, carbon, graphite, graphene, metal organic frameworks, covalent organic frameworks and/or some other chemical or compound that can be used as the matrix component. The binder and filler components provide the physical strength and integrity of the catalyst. The binder can include silica sol, silica, MgO, CaO, scandium oxide, titanium oxide, vanadium oxide, chromium oxide, manganese oxide, iron oxide, zirconia, niobia, molybdenum oxide, hafnium oxide, titaniates, zirconates, plumbates, niobates, carbon, graphite, graphene, metal organic frameworks, covalent organic frameworks for some other chemical and/or compound that can be used to provide physical strength and integrity to the catalyst. The filler can include a clay (e.g., kaolin), zinc oxide, titanium oxide, carbon black, silicates, MgO, CaO, scandium oxide, titanium oxide, vanadium oxide, chromium oxide, manganese oxide, iron oxide, zirconia, niobia, molybdenum oxide, hafnium oxide, titaniates, zirconates, plumbates, niobates, carbon, graphite, graphene, metal organic frameworks, covalent organic frameworks and/or some other chemical or compound that can be used as a filler.

It is to be understood that other embodiments may be utilized and structural changes may be made without departing from the scope of the present disclosure. Substantial flexibility is provided by the synthetic fuel creation system in that any suitable arrangements and configuration may be provided without departing from the teachings of the present disclosure.

### Foundational Information

For purposes of illustrating certain example techniques of the synthetic fuel creation system 100, the following foundational information may be viewed as a basis from which the present disclosure may be properly explained. A number of prominent technological trends are currently afoot and these trends are changing the power delivery landscape. The growing energy demands and the increasing environmental concerns drive the transformation of power generation from primarily fossil and nuclear sources to solely renewable energy sources and the search of efficient energy management systems (conversation, storage, and delivery), to achieve a secure, reliable, and sustainable energy supply. One type of possible energy supply is synthetic fuels. Synthetic fuel or e-fuel is a liquid fuel, similar to fossil fuel. The big difference is that synthetic fuel does not come from fossil energy sources but instead, is obtained from a chemical process based on hydrogen (i.e., a hydrogen carrier) and the energy used for its manufacture is renewable.

The process of manufacturing synthetic fuel typically involves the production of renewable synthetic gas or syngas. Syngas is produced using hydrogen. The hydrogen can be acquired from almost any source that can be used to supply the hydrogen for the production of the syngas. For example, the hydrogen can be acquired from water by separating the hydrogen atoms from the oxygen atoms using an electrolysis technique. In other examples, the hydrogen can be acquired using blue hydrogen (an industry term for hydrogen produced from natural gas), turquoise hydrogen (made using a process called methane pyrolysis to produce hydrogen and solid carbon), or some other means (e.g., water gas shift reaction, as the byproduct of industrial chemical reactions, steam methane reforming). The hydrogen is then combined with the greenhouse gas CO₂. The CO₂ can be obtained either by recycling the CO₂ from industrial processes or by capturing the CO₂ from the air using special filters. When the hydrogen and CO₂ are combined, syngas can be obtained via reverse water gas shift reaction.

Currently, there are general methods for the production of renewable synthetic fuel including biofuels, which are produced from biomass and electro fuels or e-fuels, which are produced with renewable electricity. All the methods mainly use syngas and the syngas is turned into liquid fuels via industrial gas-to-liquid processes.

While several processes exist to convert biomass into liquid fuels, the most scalable and most versatile in terms of feedstock goes through the gasification of the biomass. More specifically, the biomass is converted into syngas at high temperatures. The heat input required to drive the process is usually generated by burning a part of the biomass itself. Feedstocks can be ad-hoc grown plants (e.g., energy crops such as sugar cane or corn), waste biomass, or algae. However, growing biomass to create synthetic fuels uses arable land and water that could be used in the food industry. Also, the biomass methods used to create synthetic fuels have limited scalability.

E-fuels are produced from renewable electricity, such as solar, wind, or hydropower. The generated renewable electricity drives an electrolyzer that splits water into hydrogen and oxygen. The hydrogen is mixed with carbon dioxide and turned into syngas via the reverse water gas shift (RWGS) reaction, a process that is conducted at high temperatures and driven with combusted fuels (e.g., natural gas) or electricity. E-fuels can be produced with any type of renewable electricity; thus, they could theoretically be produced around the world. However, there are currently no known economically viable industrial e-fuel systems that allow for a process to create synthetic fuel. What is needed is an e-fuel system that allows for an economically viable industrial process to create synthetic fuel.

A system, method, apparatus, means, etc. to help enable a synthetic fuel creation system can help resolve these issues (and others). For example, a synthetic fuel system (e.g., the synthetic fuel creation system 100) can create electro fuels (e-fuels) using synthesis gas (syngas). In an example, the synthetic fuel creation system can include a gas creation station (e.g., the gas creation station 102), a crude creation station (e.g., the crude creation station 104), and a crude cracking station (e.g., the crude refining station 106).

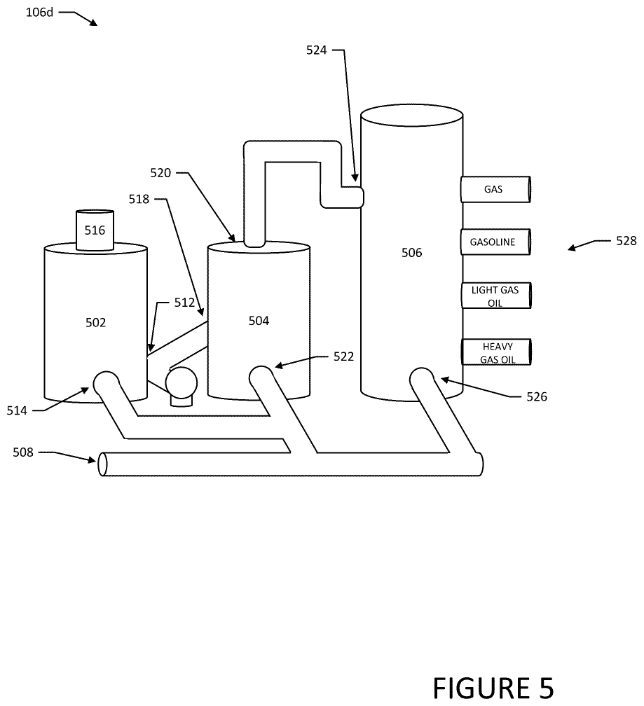

The gas creation station can be configured to produce syngas. More specifically, the gas creation station uses an electrocatalytic water splitting and carbon dioxide reduction reaction to form syngas, H₂+CO. The syngas can be formed using co-electrocatalysis: H₂O+CO₂→H₂+CO+O₂ and/or the hydrogen and CO can be formed separately to be combined later: CH₄→2H₂+C(s) and CO₂→CO+½O₂. The CO₂ can be sourced from direct air capture (e.g., as illustrated in FIGS. 6A and 6B) or sourced from industrial methods such as a flue-gas capture.

The syngas creation can be at least partially enabled by photoelectrocatalysts, electrocatalysts, plasma reforming, or some other means. PVIE can allow one or more photovoltaic (PV) cells to be utilized directly with an electrolysis reactor and a PV cell electrode can act as an electrolyzer electrode. Heat recovered from the illuminated one or more photovoltaic cells can be utilized in the reaction to help reduce overvoltage. During electrocatalysts, electrolysis can be driven using separately produced clean energy (e.g., solar wind, hydro) at relatively high currents (e.g., above 150 mA/cm²). During plasma reforming, CH₄ can be reformed to H₂ and solid carbon (C) in a plasma reactor. The solid carbon can be converted to products such as graphite, graphene, etc.

After the syngas is created, the syngas can be sent to the crude creation station. For example, the syngas can be transported to the crude creation station using a mobile transport (e.g., mobile transport 110a) such as a tanker truck, tanker train, or some other mobile transport. Also, the syngas can be transported to the crude creation station using a pipeline (e.g., direct pipeline 112a). In some examples, the gas creation station and the crude creation station are physically separate facilities and may be miles apart. In other examples, the gas creation station and the crude creation station are in the same building, facility, or within the same property boundary and may be less than about ten thousand feet or less than about mile apart. In yet other examples, the gas creation station and the crude creation station are relatively close to each other and less than about a thousand feet or less than about one hundred feet apart.

The crude creation station can be configured to convert the syngas into heavy syncrude. More specifically, the crude creation station can be configured to use the syngas in a Fischer-Tropsch process to create the heavy syncrude. The Fischer-Tropsch process is a collection of chemical reactions that converts a mixture of CO and hydrogen, the syngas, into liquid hydrocarbons. These reactions occur in the presence of metal catalysts, typically at temperatures of 150-300° C. (302-572° F.) and pressures of one to several tens of atmospheres. A variety of synthesis-gas compositions can be used.

More specifically, the Fischer-Tropsch process involves a series of chemical reactions that produce a variety of hydrocarbons, preferably having the formula (CₙH₂ₙ₊₂). For example, the reactions can produce alkanes (acyclic saturated hydrocarbons) as follows:—(2n+1)H₂+nCO→CₙH₂ₙ₊₂+nH₂O where “n” is typically 10-20. The formation of methane (n=1) is unwanted. Most of the alkanes produced tend to be straight-chain, suitable as fuel. In addition to alkane formation, competing reactions give small amounts of alkenes (hydrocarbon containing one or more double bonds), as well as alcohols and other oxygenated hydrocarbons. The reaction is a highly exothermic reaction due to a standard reaction enthalpy (ΔH) of −165 kJ/mol CO combined.

Converting a mixture of H₂ and CO into aliphatic products is a multi-step reaction with several intermediate compounds. The growth of the hydrocarbon chain may be visualized as involving a repeated sequence in which hydrogen atoms are added to carbon and oxygen, the C—O bond is split and a new C—C bond is formed. For one —CH₂— group produced by CO+2H₂→(CH₂)+H₂O, several reactions are necessary. These reactions include associative adsorption of CO, splitting of the C—O bond, dissociative adsorption of 2H₂, transfer of 2H to the oxygen to yield H₂O, desorption of H₂O, and transfer of 2H to the carbon to yield CH₂.

The conversion of CO to alkanes involves hydrogenation of CO, the hydrogenolysis (cleavage with H₂) of C—O bonds, and the formation of C—C bonds. While not fully understood, such reactions are thought to proceed via the initial formation of surface-bound metal carbonyls. In addition, the CO ligand is speculated to undergo dissociation, possibly into oxide and carbide_ligands. Other potential intermediates are various C₁ fragments including formyl (CHO), hydroxycarbene (HCOH), hydroxymethyl (CH₂OH), methyl (CH₃), methylene (CH₂), methylidyne (CH), and hydroxymethylidyne (COH). Furthermore, and critical to the production of liquid fuels, are reactions that form C—C bonds, such as migratory insertion. Migratory insertion is a type of reaction wherein two ligands on a metal complex combine. It is a subset of reactions that closely resembles the insertion reactions, and both are differentiated by the mechanism that leads to the resulting stereochemistry of the products.

Generally, the Fischer-Tropsch process is operated in the temperature range of about 150 to about 300° C. (about 302 to about 572° F.). Higher temperatures lead to faster reactions and higher conversion rates but also tend to favor methane production. For this reason, the temperature is usually maintained at the low to middle part of the range. Increasing the pressure leads to higher conversion rates and also favors formation of long-chained alkanes. Typical pressures range from one to several tens of atmospheres. Even higher pressures would be favorable, but the benefits may not justify the additional costs of high-pressure equipment, and higher pressures can lead to catalyst deactivation via coke formation.

Because the Fischer-Tropsch process is characterized by high exothermicity, efficient removal of heat from the reactor where the Fischer-Tropsch process occurs is needed. One type of reactor is a multi-tubular fixed-bed reactor. The multi-tubular fixed-bed reactor includes a number of tubes with small diameter. These tubes contain catalyst and are surrounded by cooling water which removes the heat of reaction. The multi-tubular fixed-bed reactor is suitable for operation at low temperatures and has an upper temperature limit of about 257° C. (about 530 K) because excess temperatures lead to carbon deposition and blockage of the multi-tubular fixed-bed reactor. Because large amounts of the products formed are in liquid state, the multi-tubular fixed-bed reactor is sometimes referred to as a trickle flow reactor system. Another type of reactor is an entrained flow reactor. An entrained flow reactor contains two banks of heat exchangers that remove heat, and the remainder of heat is removed by the products and recycled in the system. The formation of heavy waxes can be a problem with the entrained flow reactor system since the heavy waxes can condense on the catalyst and form agglomerations and lead to fluidization. The risers of the entrained flow reactor are typically operated over about 297° C. (about 570 K). In slurry reactors, heat removal is achieved using internal cooling coils. The synthesis gas is bubbled through the waxy products and finely-divided catalyst that is suspended in the liquid medium. This also provides agitation of the contents of the reactor. The catalyst particle size reduces diffusional heat and mass transfer limitations. A lower temperature in the reactor leads to a more viscous product and a higher temperature (> about 297° C., about 570 K) gives an undesirable product spectrum. Also, separation of the product from the catalyst is a problem. Fluid-bed and circulating catalyst (riser) reactors can be used for high-temperature Fischer-Tropsch synthesis (nearly 340° C.) to produce low-molecular-weight unsaturated hydrocarbons on alkalized fused iron catalysts.

In general the product distribution of hydrocarbons formed during the Fischer-Tropsch process follows an Anderson-Schulz-Flory distribution, and can be expressed as Wₙ/n=(1−α)²αⁿ⁻¹ where Wₙ is the weight fraction of hydrocarbons containing “n” carbon atoms, and “a” is the chain growth probability or the probability that a molecule will continue reacting to form a longer chain. In general, a is largely determined by the catalyst and the specific process conditions. The equation reveals that methane will always be the largest single product so long as “α” is less than 0.5, however, by increasing “a” close to one, the total amount of methane formed can be minimized compared to the sum of all of the various long-chained products. Therefore, increasing “a” increases the formation of long-chained hydrocarbons. The long-chained hydrocarbons are wax, and solid at room temperature.

The four metals iron, cobalt, nickel, and ruthenium are active as catalysts for the Fischer-Tropsch process. Nickel generates too much methane, so it is typically not used. Typically, such heterogeneous catalysts are obtained through precipitation from iron nitrate solutions. Such solutions can be used to deposit the metal salt onto the catalyst support. The treated materials transform into active catalysts by heating under CO, H₂, or with the feedstock to be treated (e.g., the catalysts are generated in situ). Owing to the multistep nature of the Fischer-Tropsch process, analysis of the catalytically active species is challenging. Furthermore, for iron catalysts, a number of phases may coexist and may participate in diverse steps in the reaction. Such phases include various oxides and carbides as well as polymorphs of the metals. Control of these constituents may be relevant to product distributions. Aside from iron and cobalt, nickel and ruthenium are active for converting the CO/H₂ mixture to hydrocarbons. Although expensive, ruthenium is the most active of the Fischer-Tropsch catalysts as ruthenium works at the lowest reaction temperatures and produces higher molecular weight hydrocarbons. Ruthenium catalysts consist of the metal, without any promoters, thus providing a relatively simple system suitable for mechanistic analysis. However, ruthenium's high price typically precludes industrial applications. Cobalt catalysts are more active for Fischer-Tropsch synthesis when the feedstock is natural gas. Natural gas has a high hydrogen to carbon ratio, so the water-gas shift is not needed for cobalt catalysts. Cobalt-based catalysts are more sensitive than their iron counterparts.

In some examples, the utilization or conversion of carbon dioxide into sustainable, synthetic hydrocarbons fuels, most notably for transportation purposes, can be achieved by converting carbon dioxide into synthetic hydrocarbons fuels (e.g., aviation jet fuel). Jet fuel, the generic name for the aviation fuels used in gas turbine powered aircraft has as its main components linear and branched alkanes and cycloalkanes with a typical carbon chain length distribution of C8-to-C18, and where the ideal carbon chain length is C8-C16. In an illustrative example of converting carbon dioxide into synthetic aviation jet fuel, a Fe—Mn—K catalyst can be prepared using an organic combustion method. The Fe—Mn—K catalyst shows a carbon dioxide conversion through hydrogenation to hydrocarbons in the aviation jet fuel range of 38.2%, with a yield of 17.2%, and a selectivity of 47.8%, and with an attendant low CO (5.6%) and methane selectivity (10.4%). The conversion reaction also produces light olefins ethylene, propylene, and butenes, totaling a yield of 8.7%, which are important raw materials for the petrochemical industry and are presently also only obtained from fossil crude oil.

The activation of the carbon dioxide can be extremely challenging. CO₂ is a fully oxidized, thermodynamically stable, and chemically inert molecule. Furthermore, hydrocarbon synthesis via the hydrogenation of CO₂ usually favors the formation of short-chain, rather than desirable long-chain, hydrocarbons. Typically, CO₂ is utilized by reduction into CO. Currently, there are two ways to convert CO₂ to carbon monoxide. The first is an indirect route, which converts CO₂ to CO via a reverse water gas shift (RWGS) reaction. This process requires the consumption of electrochemically-derived hydrogen. The second, direct route involves electrochemical reduction of CO₂ to CO and is generally recognized as being more economical and environmentally acceptable as it involves fewer chemical process steps, and the overall energy consumption for the entire process is lower. This process and required catalyst systems are much less developed, and innovation is necessary to commercialize. Both routes require a subsequent hydrogenation of CO to long-chain hydrocarbons via a Fischer-Tropsch synthesis (FTS).

The relevant chemical reactions for hydrocarbon fuel production are:

The hydrogenation of CO₂: CO₂+3H₂⇄—(CH₂)—+2H₂O(ΔH⁰₂₉₈=−125 kJ mole⁻¹)

The RWGS reaction: CO₂+H₂⇄CO+H₂O(ΔH⁰₂₉₈=+41 kJ mole⁻¹)

The FTS reaction: CO+2H₂⇄—(CH₂)—+2H₂O(ΔH⁰₂₉₈=−166 kJ mole⁻¹)

The direct conversion of CO₂ into fuels through these various reactions has attracted great attention in recent years. However, currently, there are few if any reports of the direct catalytic conversion of CO₂ to jet fuel range hydrocarbons and they suffer from low yields or reaction efficiencies. One key to advancing this process is to identify a highly efficient inexpensive catalyst that can preferentially synthesize the target hydrocarbon range of interest.

The rising concerns over climate change and the stringent environmental regulations to reduce the utilization of fossil derived fuels have generated great opportunities, and major scientific challenges, on the transformation of CO₂ into sustainable, synthetic hydrocarbons fuels, particularly in the synthesis of renewable aviation fuels. Currently, at the heart of any progress in this area, the all-important conversion process is closely related to the development of advanced catalysts of high performance for the conversion of CO₂ and H₂ to hydrocarbons and carbon monoxide. The utilization of novel methods of catalyst preparation represents an important strategy to produce advanced catalytic formulations having high performance levels.

### DISCUSSION OF FIGURES

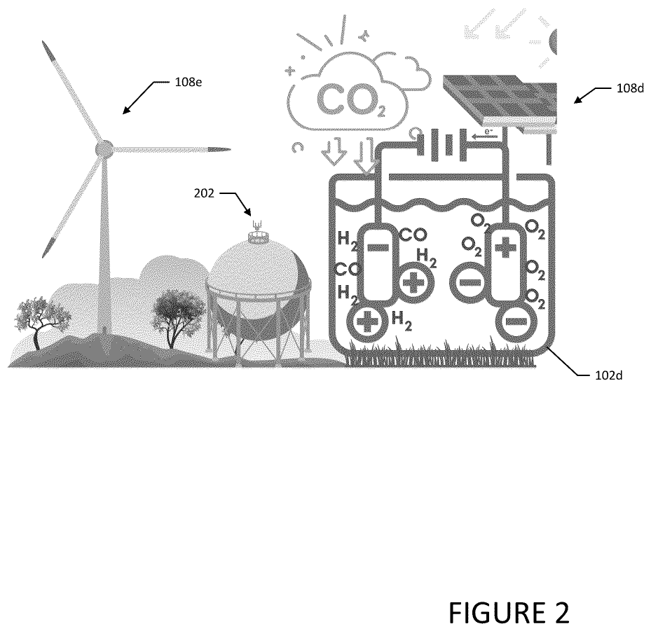

Turning to FIG. 2, FIG. 2 illustrates example details of a particular non-limiting implementation of a gas creation station 102d, in accordance with an embodiment of the present disclosure. As illustrated in FIG. 2, The gas creation station 102d can create synthesis gas or syngas. In some examples, the gas creation station 102d includes a reactor with a hydrogen/CO electrode and an oxygen electrode as the cathode and anode electrodes, respectively. The syngas produced from the gas creation station 102d can be stored in syngas storage container 202. The stored syngas can then be sent to the crude creation station 104a (FIG. 1A) using a mobile transport 110a (FIG. 1A), a direct pipeline 112a (FIG. 1A), or some other means.

The power station 108 can help provide power to the gas creation station 102. In some examples, the power station 108 is a renewable energy power station. For example, as illustrated in FIG. 2, a power station 108d may include one or more solar cells or an array of solar cells, a power station 108e may include one or more wind turbines or windmills (e.g., a wind farm), or some other type of renewable energy power station.

In some examples, the gas creation station 102d can extract CO₂ from the environment (e.g., using the direct air capture (DAC) system 602 illustrated in FIGS. 6A and 6B or some other system to extract CO₂ from the ambient air) around the gas creation station 102d and create synthesis gas or syngas. More specifically, the gas creation station 102d can create the syngas using a photoelectrocatalysis process, an electrocatalysis process, a plasma reforming process, or some other type of process. A PVIE can allow the power station 108d to be utilized directly in the reactor with the reactor acting as an electrode surface. Heat recovered from the illuminated one or more photovoltaic cells of the power station 108d can be utilized in the reaction to help reduce overvoltage.

In the electrocatalysis process, electrolysis can be driven using separately produced clean energy from the power station 108d, the power station 108e, or some other energy power station at relatively high currents (e.g., above 150 mA/cm²). During the plasma reforming process, CH₄ can be reformed to H₂ and solid carbon (C) in a plasma reactor. The solid carbon can be converted to products such as graphite, graphene, etc.

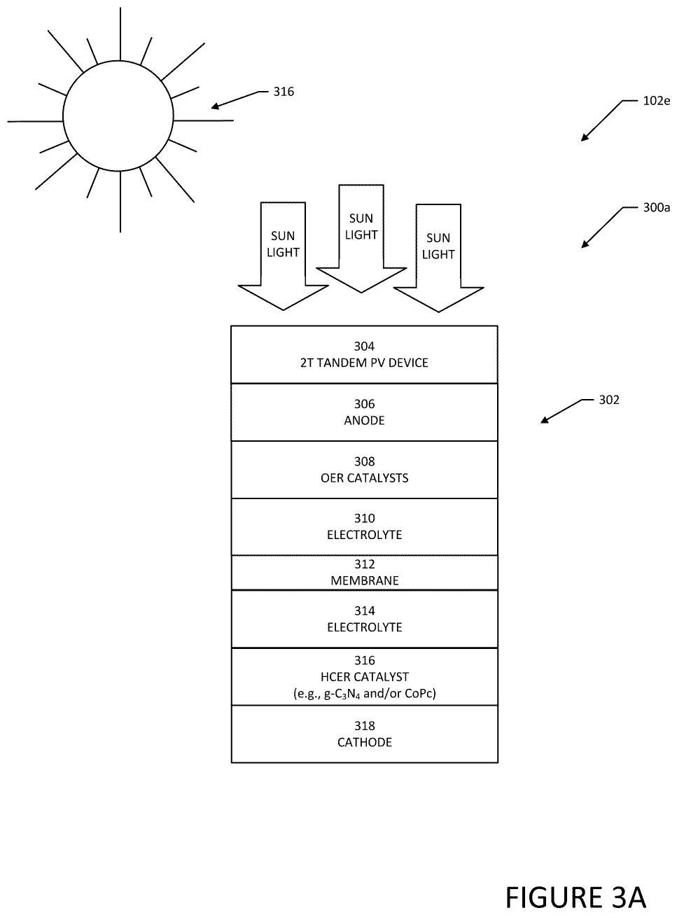

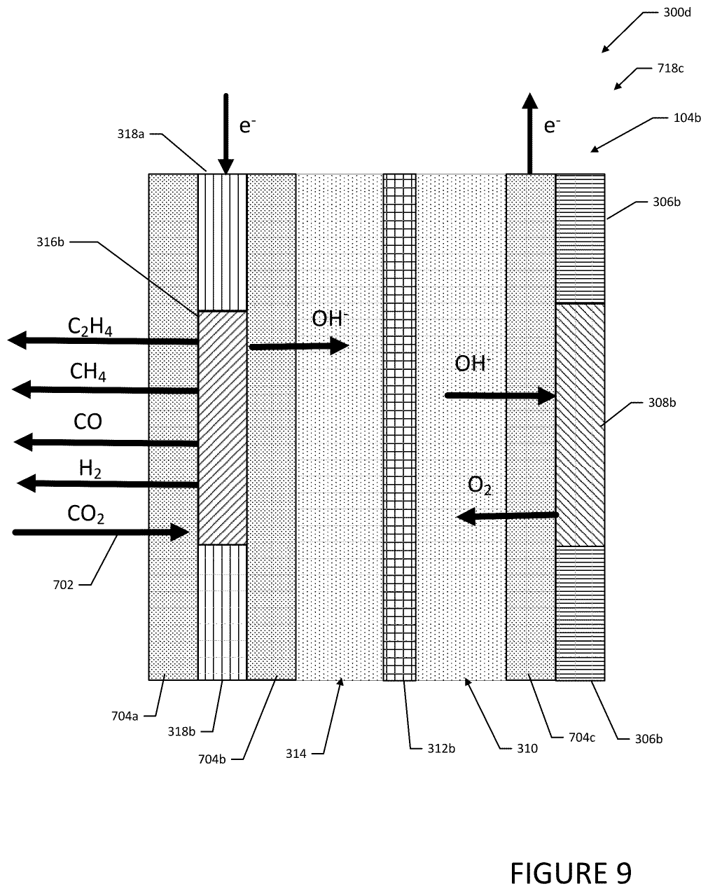

Turning to FIG. 3A, FIG. 3A illustrates example details of a particular non-limiting implementation of a portion of a gas creation station 102e using a PV-driven electrocatalysis system 300a to help create syngas, in accordance with an embodiment of the present disclosure. As illustrated in FIG. 3A, the PV-driven electrocatalysis system 300a can include a PVIE 302. The PVIE 302 can include a two terminal (2T) tandem PV device 304, an anode 306, one or more OER catalysts 308, a first electrolyte 310, a membrane 312, a second electrolyte 314, one or more HCER catalysts 316, and a cathode 318. The first electrolyte 310 and the second electrolyte 314 can each be a liquid, an aqueous solution, a solid, a gel, or some other type of solution. In some examples, there is only one electrolyte (e.g., either only the first electrolyte 310 or only the second electrolyte 314) in combination with a proton membrane, a hydroxide conductive membrane, or some other similar type membrane (e.g., a zero-gap configuration as illustrated in FIG. 10).

Note that the 2T tandem PV device 304 acts as the power station 108 for the PV-driven electrocatalysis system 300a. The one or more OER catalysts 308 help to facilitate the oxygen evolution reaction as described above (2H₂O→O₂+4H⁺). The membrane 312 is a reaction separating membrane. The one or more HCER catalyst 316 help to facilitate the co-electrolysis as described above (H₂O+CO₂→H₂+CO+O₂). In some examples, the first electrolyte 310 and the second electrolyte 314 are the same.

In an example, the gas creation station 102e can use pressurized CO₂ to help control the pH of the system. In a specific example, the one or more HCER catalysts 316 include a g-C₃N₄ catalyst. In some examples, metals, such as Cu, Ag, Au, Ni, Pd, Pt, Co, Rh, Ir, Fe, Ru, Os, or other Lewis acids may be used to modify the catalytic and/or electronic properties of the g-C₃N₄. For example, in a specific illustrative example, about one mole percent (1%) to about thirty mole percent (30%), and ranges therein (e.g., 9.5 mole percent, 10.25 mole percent, 10.75 mole percent, etc.), of Au or Ag may be embedded in the g-C₃N₄. In another specific illustrative example, about five mole percent (5%) to about fifteen mole percent (15%), and ranges therein (e.g., 9.5 mole percent, 10.25 mole percent, 10.75 mole percent, etc.), of Au or Ag may be embedded in the g-C₃N₄. In a specific example, about ten mole percent (10%) of Au or Ag may be embedded in the g-C₃N₄. In some examples, the one or more HCER catalysts 316 include the g-C₃N₄ catalysts and a CoPc catalyst embedded into a CNT matrix. In some examples, hydrogen reduction is further promoted by addition of platinic acid (H₂PtCl₆) as a Pt source. The Pt can be in very low concentrations (e.g., 0.0024 mg/cm²) and likely forms very small (single atom or small nanoparticle) active sites within the matrix for H₂ formation. The CoPc catalyst embedded into a CNT matrix with added Pt can help produce syngas in a desired H₂/CO ratio of 2:1 for Fischer-Tropsch synthetic fuels production.

While a specific order of the anode 306, one or more OER catalysts 308, and the first electrolyte 310 is illustrated in FIG. 3A for the PVIE 302 and each of the anode 306, the one or more OER catalysts 308, and the first electrolyte 310 are shown separated from each other, the anode 306, the one or more OER catalysts 308, and the first electrolyte 310 may have a different order and/or one or more of the anode 306, the one or more OER catalysts 308, and the first electrolyte 310 may be integrated together. Also, while a specific order of the second electrolyte 314, the one or more one or more HCER catalysts 316, and the cathode 318 is illustrated in FIG. 3A for the PVIE 302 and each of the second electrolyte 314, the one or more HCER catalysts 316, and the cathode 318 are shown separated from each other, the second electrolyte 314, the one or more HCER catalysts 316, and the cathode 318 may have a different order and/or the one or more of the second electrolyte 314, the one or more HCER catalysts 316, and the cathode 318 may be integrated together.

For example, in some embodiments of the PVIE 302, the first electrolyte 310 may be between the anode 306 and the one or more OER catalysts 308, and/or the second electrolyte 314 may be between the cathode 318 and the one or more HCER catalysts 316. In some embodiments, the one or more HCER catalysts 316 and/or the one or more OER catalysts 308 may be porous and the first electrolyte 310 may co-exist within the one or more OER catalysts 308 as one layer and/or the second electrolyte 314 may co-exist within the one or more HCER catalysts 316 as one layer. In addition, in a proton exchange membrane electrolyzer, it is common that the second electrolyte 314 is not present, however the second electrolyte 314 may be present in a proton exchange membrane electrolyzer, and in an anion exchange membrane electrolyzer, it is common that the first electrolyte 310 is not be present, but the first electrolyte 310 may be present in an anion exchange membrane electrolyzer.

A common proton exchange membrane electrolyzer would operate under acidic conditions, pH<7, and the electrolyte would circulate through the first electrolyte 310. The water splitting reaction would occur using the one or more OER catalysts 308 to produce oxygen and protons. The protons would travel through the proton exchange membrane and be reduced to H₂ and the second electrolyte 314 would be optional. A common anion exchange membrane electrolyzer would operate under alkaline conditions, pH>7, and the electrolyte would circulate through the second electrolyte 314. The water splitting reaction would occur using the one or more HCER catalysts 316 to produce H₂ and OH-anions. The OH anions would travel through the anion exchange membrane and be oxidized to water and oxygen and the first electrolyte 310 would be optional.

Turning to FIG. 3B, FIG. 3B illustrates example details of a particular non-limiting implementation of a portion of a gas creation station 102e using a PV-driven electrocatalysis system 300b to help create syngas, in accordance with an embodiment of the present disclosure. As illustrated in FIG. 3B, the PV-driven electrocatalysis system 300b can include the power station 108a and a PV-EC 320. The power station 108a may include one or more solar cells or an array of solar cells. While not illustrated in FIG. 3B, in some examples the power station 108a may be similar to the power station 108e (illustrated in FIG. 2) and can include one or more wind turbines or windmills (e.g., a wind farm), or some other type of renewable energy power station. The PV-EC 320 can include the anode 306, the one or more OER catalysts 308, the first electrolyte 310, the membrane 312, the second electrolyte 314, the one or more HCER catalysts 316, and the cathode 318.

While a specific order of the anode 306, one or more OER catalysts 308, and the first electrolyte 310 is illustrated in FIG. 3B for the PV-EC 320 and each of the anode 306, the one or more OER catalysts 308, and the first electrolyte 310 are shown separated from each other, the anode 306, the one or more OER catalysts 308, and the first electrolyte 310 may have a different order and/or one or more of the anode 306, the one or more OER catalysts 308, and the first electrolyte 310 may be integrated together. Also, while a specific order of the second electrolyte 314, the one or more HCER catalysts 316, and the cathode 318 is illustrated in FIG. 3B for the PV-EC 320 and each of the second electrolyte 314, the one or more HCER catalysts 316, and the cathode 318 are shown separated from each other, the second electrolyte 314, the one or more HCER catalysts 316, and the cathode 318 may have a different order and/or the one or more of the second electrolyte 314, the one or more HCER catalysts 316, and the cathode 318 may be integrated together.

For example, in some embodiments of the PV-EC 320, the first electrolyte 310 may be between the anode 306 and the one or more OER catalysts 308, and/or the second electrolyte 314 may be between the cathode 318 and the one or more HCER catalysts 316. In some embodiments, the one or more HCER catalysts 316 and/or the one or more OER catalysts 308 may be porous and the first electrolyte 310 may co-exist within the one or more OER catalysts 308 as one layer and/or the second electrolyte 314 may co-exist within the one or more HCER catalysts 316 as one layer. In addition, in a proton exchange membrane electrolyzer, it is common that the second electrolyte 314 is not present, but the second electrolyte 314 can be present in a proton exchange membrane electrolyzer and in an anion exchange membrane electrolyzer, the first electrolyte 310 may not be present, but the first electrolyte 310 can be present in an anion exchange membrane electrolyzer.

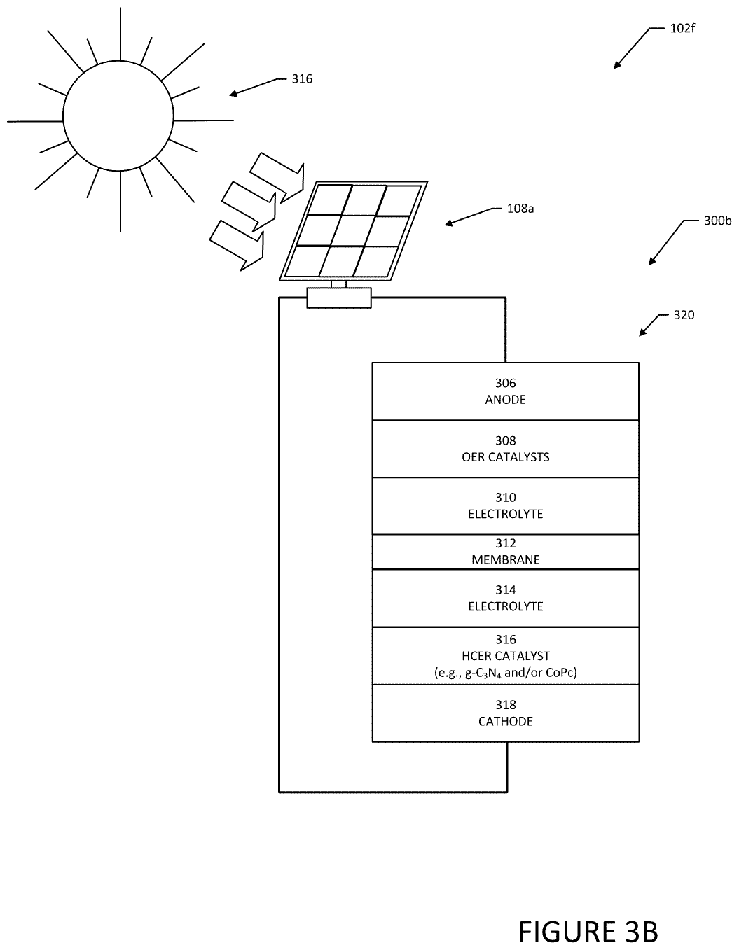

Turning to FIG. 4, FIG. 4 illustrates example details of a particular non-limiting implementation of a portion of a crude creation station 104d, in accordance with an embodiment of the present disclosure. As illustrated in FIG. 4, the crude creation station 104d can include a reaction chamber 402, a syngas inlet 404, a cooling water inlet 406, a catalyst intel 408, a gas product and syngas outlet 410, a liquid products and catalyst outlet 412, and a steam outlet 414. The liquid products and catalyst outlet 412 can help transfer liquid products and catalyst from the reaction chamber 402 to a liquid products and catalyst separator 416. The liquid products and catalyst separator 416 can separate the liquid products and catalyst from the reaction chamber 402 into liquid products and catalyst. The catalyst can be reintroduced into the reaction chamber 402 using the catalyst intel 408. The liquid products can be heavy syncrude. The heavy syncrude can be stored in heavy syncrude storage container (not shown). The stored heavy syncrude can then be sent to the crude refining station 106 using a mobile transport 110b (FIG. 1A), a direct pipeline 112b (FIG. 1A), or some other means.

Turning to FIG. 5, FIG. 5 illustrates example details of a particular non-limiting implementation of a portion of a crude refining station 106d, in accordance with an embodiment of the present disclosure. As illustrated in FIG. 5, the crude refining station 106d can include a regenerator 502, a reaction chamber 504, a fractionator 506, and a heavy crude inlet 508. The regenerator 502 can include a spent catalyst inlet 512, a refreshed catalyst outlet 514, a heat and gas impurities outlet 516, and an air inlet (not referenced). The spent catalyst inlet 512 can receive spent catalyst from a spent catalyst outlet 518 of the reaction chamber 504. The reaction chamber 504 can include the spent catalyst outlet 518, a cracked cuts outlet 520, and a combined heavy crude, refreshed catalyst, and cycle oil input 522. The fractionator 506 can include a cracked cuts inlet 524, a cycle oil output 526, and one or more synthetic fuel outlets 528. Heavy crude from the heavy crude inlet 508, refreshed catalyst from the refreshed catalyst outlet 514 of the regenerator 502, and cycle oil from the cycle oil output 526 of the fractionator 506 can be combined and introduced into the reaction chamber 504 using the combined heavy crude, refreshed catalyst, and cycle oil input 522.

The crude refining station 106d can be configured to perform a refinery process designed to produce synthetic gasoline out of the heavy syncrude created by the crude creation station 104. In an illustrative example, straight-run heavy gas oil and flasher tops along with a catalyst are pumped into the reaction chamber 504. The reaction chamber 504 can be a high-temperature moderate-pressure reaction chamber, where conversion of the heavy crude into cracked cuts occurs. During the conversion process, in the reaction chamber 504, coke (carbon) coats the catalyst and it becomes ineffective (spent). To remove the coke, the spent catalyst is sent to the regenerator 502 and combined with hot air to refresh the catalyst. The refreshed catalyst is then sent back into the reaction chamber 504.

The cracked cuts from the reaction chamber 504 are pumped into the fractionator 506, where they are separated into synthetic gasoline, synthetic light gas oil (e.g., kerosene), and synthetic heavy gas oil (e.g., diesel). In some examples, natural gas can be extracted from the fractionator 506 along with cycle oil. The cycle oil can be sent into the reaction chamber 504.

Turning to FIGS. 6A and 6B, FIGS. 6A and 6B illustrates example details of a particular non-limiting implementation of a direct air capture (DAC) system 602 for capturing CO₂ from the air, in accordance with an embodiment of the present disclosure. The direct air capture system 602 can be part of the gas creation station 102 illustrated in FIGS. 1A-1C. Direct air capture is the use of chemical or physical processes to extract carbon dioxide directly from the ambient air. As illustrated in FIG. 6A, a fan 604 can draw in ambient air that includes CO₂. The ambient air is forced through filters 606 that capture the CO₂ in the ambient air. As illustrated in FIG. 6B, the filters 606 with the captured CO₂ can be treated (e.g., by heating) to release the CO₂. The released CO₂ can be captured and stored in a CO₂ storage container 608 or utilized in the creation of syngas.

In an example, the CO₂ removal from the ambient air can be achieved when ambient air makes contact with a chemical media, typically an aqueous alkaline solvent or sorbents. These chemical media are subsequently stripped of the CO₂ through the application of energy (namely heat), resulting in a CO₂ stream that can undergo dehydration and compression, while simultaneously regenerating the chemical media for reuse. This is contrast to another means of capturing CO₂ called carbon capture and storage (CCS) which captures CO₂ from point sources, such as a cement factory or a bioenergy plant.

In an illustrative example, the direct air capture system 602 can capture air by drawing or sucking in air from the atmosphere using one or more fans 604 or some other means. The captured air passes through filters 606 that grab and concentrate the CO₂ that is in the captured air. The filters 606 can attract the CO₂ using sorbents (small solid materials that are typically structured in layers or honeycomb-like shapes) liquid solvents, or some other means of attracting the CO₂. The filters 606 that captured the CO₂ can be heated to release the captured CO₂. The amount of heat required for this process affects how the facilities are powered. Sorbents require lower levels of heat to extract CO₂, so these facilities can use renewable energy sources like geothermal or waste heat. Solvents, on the other hand, require levels of heat of about 900 degrees Celsius and often natural gas is used to generate the required heat. The released CO₂ can be captured and stored in one or more CO₂ storage containers 608 for later use or used by the gas creation station 102 (illustrated in FIGS. 1A-1C) to create syngas. In other embodiments, the filters 606 may directly filter CO₂ from the air by size-exclusion or other means.

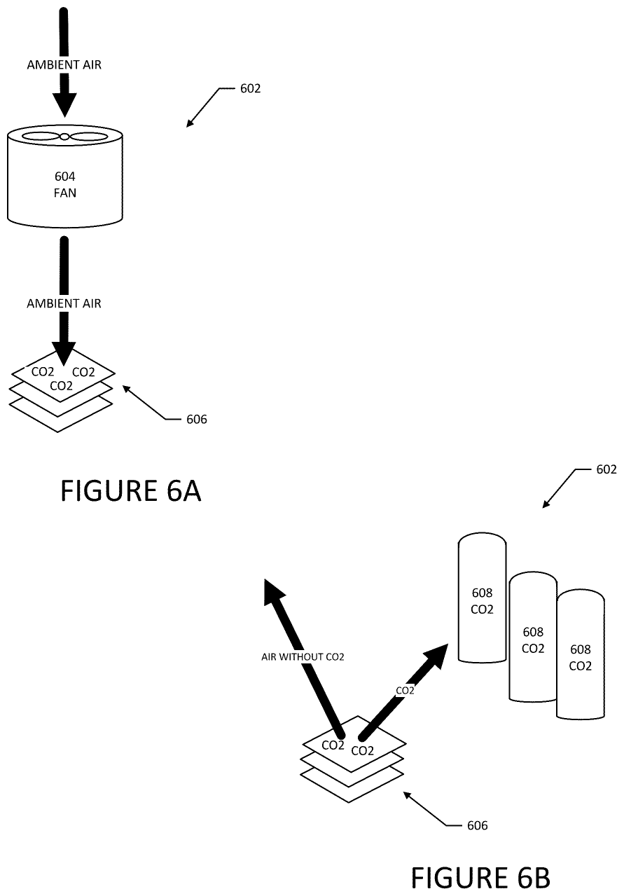

Turning to FIG. 7, FIG. 7 is an exploded view of a particular non-limiting implementation of a portion of a reaction vessel 718a in an electrocatalysis system 300c in the gas creation station 102 to help create syngas, in accordance with an embodiment of the present disclosure. The electrocatalysis system 300c is just one example of an aqueous flow reactor to help create syngas. As illustrated in FIG. 7, the electrocatalysis system 300c can include the power station 108, an anode 306a, one or more OER catalysts 308a, the first electrolyte 310 (not shown), a membrane 312a, the second electrolyte 314 (not shown), one or more HCER catalysts 316a, a cathode 318a, pressurized CO₂ 702, a second electrolyte reservoir 712, and a first electrolyte reservoir 714. In some examples, the electrocatalysis system 300c can also include one or more supports 704, an OER catalysts membrane 706, a HCER catalysts membrane 708, and/or a quality control engine 710.

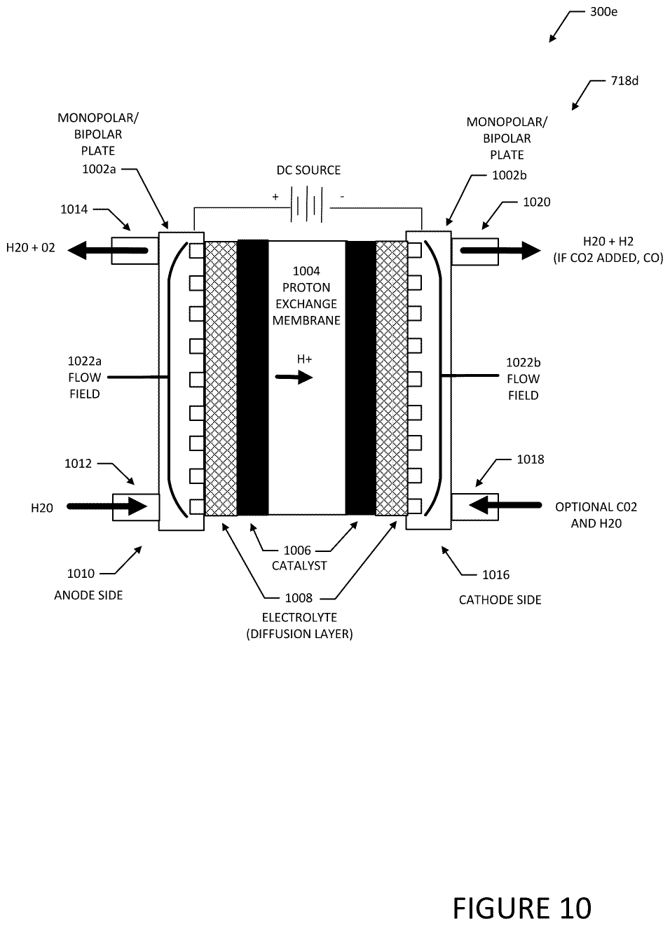

The first electrolyte 310 can be an anolyte and the second electrolyte 314 can be a catholyte. In some examples, the first electrolyte 310 is different than the second electrolyte 314. In other examples, the first electrolyte 310 and the second electrolyte 314 are the same electrolyte. In yet other examples, only the first electrolyte 310 is present in the electrocatalysis system 300c and not the second electrolyte 341. In addition, in other examples, only the second electrolyte 314 is present in the electrocatalysis system 300c and not the first electrolyte 310. For example, in an electrolyzer cell with an anion exchange membrane (FIG. 11) or a proton exchange membrane (FIG. 10), often one side is zero-gap (no fluid flow) and only the other side has fluid flow.

The pressurized CO₂ 702 can be captured and pressurized CO₂. The CO₂ may be from any CO₂ source. In some examples, the system can be pressurized with CO₂ in water and the dissolved CO₂ reduces the pH of the second electrolyte 314 (catholyte) and creates ions to act as electrolyte. In another example, pressurized CO₂ in water reduces the pH of the second electrolyte 314 (catholyte) and an electrolyte (either the first electrolyte 310 or the second electrolyte 314) is still used. In another example, acid and electrolyte are still added and pressurized CO₂ supplements one or both. Water is the key solvent, but any protic solvent may be used (e.g., methanol, ethanol, propanol, butanol, higher alcohols, and their isomers). In some examples, additional second electrolyte 314 (catholyte) can be added from the second electrolyte reservoir 712 and/or additional first electrolyte 310 (anolyte) can be added from the first electrolyte reservoir 714.

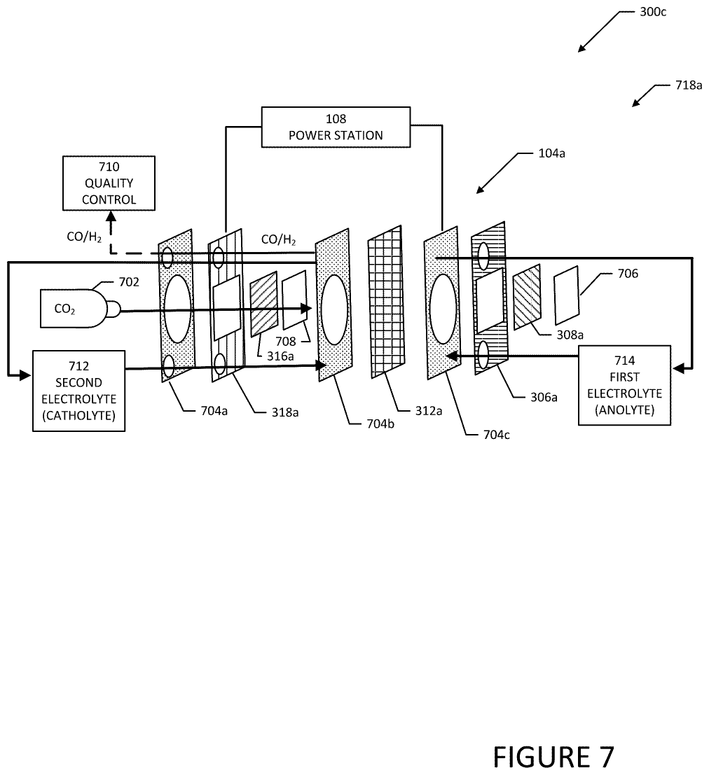

The one or more supports 704 can be support plates or some other material or structure that helps to support the anode 306a and/or cathode 318a (e.g., as illustrated in FIG. 8, supports 704a and 704b can sandwich the cathode 318a to help support the cathode 318a and support 704c can help support the anode 306a). Because the electrocatalysis system 300c is a pressurized system, the one or more supports 704 can help to contain the first electrolyte and the second electrolyte. The supports 704a and 704b can include one or more cavities or holes to allow the pressurized CO₂ and the first electrolyte 310 to flow through and circulate throughout the cathode side of the electrocatalysis system 300c and the support 704c can include one or more cavities or holes to allow the second electrolyte 314 to flow through and circulate throughout the anode side of the electrocatalysis system 300c. In some examples, the cathode 318a is a gas permeable electrode. More specifically, the cathode 318a can be a graphite electrode, a foam, or carbon electrode that is porous, or some other CO₂ gas permeable electrode, depending on the HCER catalyst 316a, that allows for the CO₂ and H₂ reduction The cathode 318a can include C—Au-500 NWs, Au-Cb NPs, Au_CeOx/C, OD-Ag, Ag—SCN, Ag—IO, 5 nm-Ag/C, Pd/C, NaHCO₃, Au NPs-8 nm, Au/CNT-as-deposited, Nanoporous Ag, Triangular Ag nanoplates, CdS—CNTs, C—Cu/In₂O_{3-0.8}, C—Cu/SnO₂-0.8, h-Zn, Zn_{0.4}Cd_{0.6}S-Amine, Vo-rich ZnO, Zn-3, CoNi—NC, Co@CoNC-900, Fe³⁺—N—C/DGE, A-Ni-NSG, CdS_{0.75}Se_{0.25}, MoSeS, AgCu-50, AuCu₂/CNT, Au₃Cu, Cu—In, CuIn, Cu_{0.75}In_{0.25}, Ni_{0.2}In_{0.75}, NG-800, OA-PCN, S,N-doped carbon, NCNTs, CN—H—CNTs, CCG/CoPc-A, Ni-N3-V SAC, Ni-NG/CFP, FC, or some other material that can act as the cathode 318a as described herein. The one or more HCER catalysts 316a can include Au, Ag, Pd Pt, Cu, Ni, six former as nanoparticles on carbon, hexagonal Zn, an alloy, for example, CuNi, CuSn, CuPb, CuZn, CuCd, CuAg, AuCu, AggCu₂, ZnCu, CuCd, Cu₁₁In₉, carbon nitride, carbon nitride with Au, ([Nill(tris(N-methylbenzimidazol-2-ylmethyl)amine)(CH₃CN)₂] (BF₄)₂), Fe-porphyrin-based metal-organic framework (PCN-222(Fe)) with carbon black, ([Rull(tpy)-(Mebim-py)(H₂O)]2+ (tpy=2,20:60,200-terpyridine; Mebim-py=3-methyl1-pyridylbenzimidazol-2-ylidene), or some other material that can act as the one or more HCER catalysts 316a as described herein. In a specific example, the HER catalysts 316a include g-C₃N₄. In some examples, metals, such as Cu, Ag, Au, Ni, Pd, Pt, Co, Rh, Ir, Fe, Ru, Os, or other Lewis acids may be used to modify the catalytic and/or electronic properties of the g-C₃N₄. For example, in a specific illustrative example, about one mole percent (1%) to about thirty mole percent (30%), and ranges therein (e.g., 9.5 mole percent, 10.25 mole percent, 10.75 mole percent, etc.), of Au or Ag may be embedded in the g-C₃N₄. In another specific illustrative example, about five mole percent (5%) to about fifteen mole percent (15%), and ranges therein (e.g., 9.5 mole percent, 10.25 mole percent, 10.75 mole percent, etc.), of Au or Ag may be embedded in the g-C₃N₄. In a specific example, about ten mole percent (10%) of Au or Ag may be embedded in the g-C₃N₄. In another specific example, the one or more HCER catalysts 316a include g-C₃N₄ or a CoPc catalyst embedded into a CNT matrix. In yet another specific example, the one or more HCER catalysts 316a include g-C₃N₄ and a CoPc catalyst embedded into a CNT matrix. In yet another specific example, the one or more HCER catalysts 316a include g-C₃N₄ and/or the CoPc catalyst embedded into a CNT matrix with the addition of platinic acid (H₂PtCl₆) as a platinum (Pt) source. In some examples, the HER catalysts 316a include or is suspended in an isopropanol (IPA) solvent. The anode 306a can be a nickel foam or, depending on the OER catalysts 308a, some other type of material that allows for H₂O oxidation. The OER catalysts 308a can include IrO₂, Ru:IrO₂, Ni, Ni foam, NiO, Ni_{X}O_{y}, doped nickel oxides, Ru, Ru:NiO, multi-metal oxides and hydroxides (MnCo₂O₄, NiCo₂O₄), FeNi double hydroxide, multi-metal sulfides and chalcogens (Fe—Ni3S2) and multi-metal phosphides and nitrides (O—Ni₍₁₋ₓ₎FeₓP₂) or some other material that can act as the OER catalysts 308a as described herein.

The active portion of the anode 306a is where the OER catalyst 308a is located and the active portion of the cathode 318a is where the one or more HCER catalysts 316a are located. In some examples, because the electrocatalysis system 300c is a pressurized system, the OER catalysts membrane 706 can help protect the OER catalyst 308a and the HCER catalysts membrane 708 can help protect the one or more HCER catalysts 316a.

Turning to FIG. 8, FIG. 8 is a block diagram of a portion of the reaction vessel 718b in the electrocatalysis system 300c in the gas creation station 102 to help create syngas, in accordance with an embodiment of the present disclosure. The electrocatalysis system 300c is just one example of an aqueous flow reactor to help create syngas. As illustrated in FIG. 8, the electrocatalysis system 300c can include the anode 306a, the one or more OER catalysts 308a, the first electrolyte 310, the membrane 312a, the second electrolyte 314, the one or more HCER catalysts 316a, the cathode 318a, pressurized CO₂ 702, and the one or more supports 704. The membrane 312a can be a proton exchange membrane.

While a specific order of the anode 306a, the one or more OER catalysts 308a, and the first electrolyte 310 is illustrated in FIG. 8 and each of the anode 306a, the one or more OER catalysts 308a, and the first electrolyte 310 are shown separated from each other, the anode 306a, the one or more OER catalysts 308a, and the first electrolyte 310 may have a different order and/or one or more of the anode 306a, the one or more OER catalysts 308a, and the first electrolyte 310 may be integrated together. Also, while a specific order of the second electrolyte 314, the one or more HCER catalysts 316a, and the cathode 318a is illustrated in FIG. 8 and each of the second electrolyte 314, the one or more HCER catalysts 316a, and the cathode 318a are shown separated from each other, the second electrolyte 314, the one or more HCER catalysts 316a, and the cathode 318a may have a different order and/or the one or more of the second electrolyte 314, the one or more HCER catalysts 316a, and the cathode 318a may be integrated together.

The pressurized CO₂ 702 can be captured and pressurized CO₂. The CO₂ may be from any CO₂ source. The system can be pressurized with CO₂ in water and the dissolved CO₂ reduces the pH of the second electrolyte 314 (catholyte) and creates ions to act as electrolyte. In another example, pressurized CO₂ in water reduces the pH of the second electrolyte 314 (catholyte) and an electrolyte (either the first electrolyte 310 or the second electrolyte 314) is still used. In another example, acid and electrolyte are still added and pressurized CO₂ supplements one or both. Water is the key solvent, but any protic solvent may be used (e.g., methanol, ethanol, propanol, butanol, higher alcohols, and isomers).

The one or more supports 704 can be support plates or some other material or structure that helps to support the anode 306a and/or cathode 318a. For example, as illustrated in FIG. 8, supports 704a and 704b can sandwich the cathode 318a to help support the cathode 318a and support 704c can help support the anode 306a. The supports 704a and 704b can include one or more cavities or holes (not shown) to allow the CO₂ (in some examples, the CO₂ is pressurized CO₂) and the first electrolyte to flow through and circulate throughout the cathode side of the electrocatalysis system 300c and the support 704c can include one or more cavities or holes to allow the second electrolyte to flow through and circulate throughout the anode side of the electrocatalysis system 300c.

The desired reaction in the electrocatalysis system 300c is:

XH₂O+CO₂→YH₂+CO+ZO₂

X, Y, and Z can have values from about 0.1 to about 3.5 and ranges therein. X, Y, and Z can be the same, but do not need to be the same or approximately the same. For example, X, Y, and Z can all be equal to one (1), X and Y can be equal to two (2) and Z can be equal to 1.5, or X and Y can be equal to three (3) and Z can be equal to two (2).

In some examples, to help achieve the desired reaction (XH₂O+CO₂→YH₂+CO+ZO₂) in the electrocatalysis system 300c, the reaction vessel 718b can be pressurized using pressurized CO₂. For example, a pH of below five (5) can be achieved by using pressurized CO₂ in the reaction vessel 718b. More specifically, inside the reaction vessel 718b, the following reaction can occur:

CO₂(aq)+H₂O(l)⇄H₂CO₃(aq)=HCO₃⁻(aq)+H⁺(aq)

The left pka is equal to about 6.36, the equilibrium constant Kₕ is equal to about 1.70×10⁻³, the right pKa1 is equal to about 3.60, and the right pKa2 is equal to about 10.25. At greater than about 10⁻² atm partial pressure of CO₂ (P_{CO2}) in H₂O, carbonic acid begins to dominate the equilibrium and the pH of solution drops below a pH of about five (5). At a CO₂ pressure (P_{CO2}) equal to about ten (10) atm, the solution is CO₂-saturated and the left reaction equilibrium is overcome. In contrast, in some current systems, the required acidic conditions for the reaction must be created through the addition of other acids (e.g., HCl, HNO₃ and H₂SO₄) to the electrolyte.

In some examples, the cathode 318a is a gas permeable electrode. More specifically, the cathode 318a can be a graphite electrode, a foam, or carbon electrode that is porous, or some other CO₂ gas permeable electrode, depending on the one or more HCER catalysts 316a, that allows for the CO₂ and H⁺ reduction. The anode 306a can be a nickel foam or, depending on the OER catalysts 308a, some other type of material that allows for H₂O oxidation.

The active portion of the anode 306a is where the OER catalyst 308a is located and the active portion of the cathode 318a is where the one or more HCER catalysts 316a are located. If the electrocatalysis system 300c is a pressurized system, the OER catalysts membrane 706 can help protect the OER catalyst 308a and the HCER catalysts membrane 708 can help protect the one or more HCER catalysts 316a. In an example, the one or more HCER catalysts 316a include g-C₃N₄. In another example, the one or more HCER catalysts 316a include g-C₃N₄ and/or CoPc embedded in a CNT matrix. In a yet another example, the one or more HCER catalysts 316a include g-C₃N₄ and/or CoPc embedded in a CNT matrix and Pt.

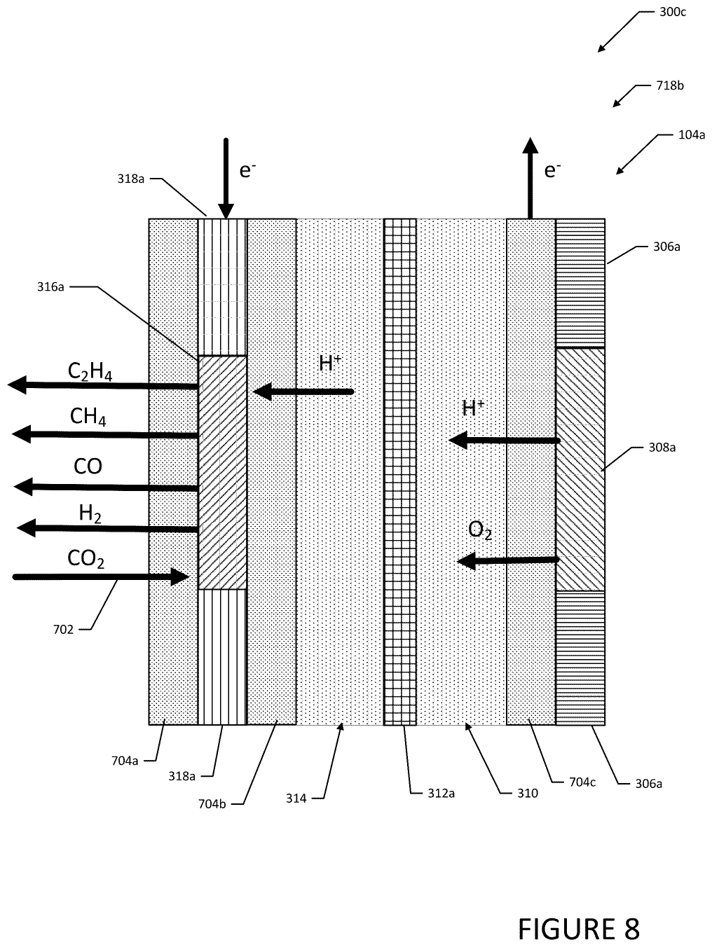

Turning to FIG. 9, FIG. 9 is a block diagram of a particular non-limiting implementation of a portion of a reaction vessel 718c in an electrocatalysis system 300d in the gas creation station 102 to help create syngas, in accordance with an embodiment of the present disclosure. The electrocatalysis system 300d is just one example of an aqueous flow reactor to help create syngas. As illustrated in FIG. 9, the electrocatalysis system 300d can include an anode 306b, one or more OER catalysts 308b, a first electrolyte 310, a membrane 312b, the second electrolyte 314, one or more HCER catalysts 316b, a cathode 318b, pressurized CO₂ 702, and a one or more supports 704. The membrane 312b can be an anion exchange membrane.

While a specific order of the anode 306b, the one or more OER catalysts 308b, and the first electrolyte 310 is illustrated in FIG. 9 and each of the anode 306b, the one or more OER catalysts 308b, and the first electrolyte 310 are shown separated from each other, the anode 306b, the one or more OER catalysts 308b, and the first electrolyte 310 may have a different order and/or one or more of the anode 306b, the one or more OER catalysts 308b, and the first electrolyte 310 may be integrated together. Also, while a specific order of the second electrolyte 314, the one or more HCER catalysts 316b, and the cathode 318b is illustrated in FIG. 9 and each of the second electrolyte 314, the one or more HCER catalysts 316b, and the cathode 318b are shown separated from each other, the second electrolyte 314, the one or more HCER catalysts 316b, and the cathode 318b may have a different order and/or the one or more of the second electrolyte 314, the one or more HCER catalysts 316b, and the cathode 318b may be integrated together.

The one or more supports 704 can be support plates or some other material or structure that helps to support the anode 306b and/or cathode 318b. For example, as illustrated in FIG. 9, supports 704a and 704b can sandwich the cathode 318b to help support the cathode 318b and support 704c can help support the anode 306b. The supports 704a and 704b can include one or more cavities or holes (not shown) to allow the CO₂ (in some examples, the CO₂ is pressurized CO₂) and the first electrolyte to flow through and circulate throughout the cathode side of the electrocatalysis system 300d and the support 704c can include one or more cavities or holes to allow the second electrolyte to flow through and circulate throughout the anode side of the electrocatalysis system 300d.

The desired reaction in the electrocatalysis system 300d is:

XH₂O+CO₂→YH₂+CO+ZO₂

X, Y, and Z can have values from about 0.1 to about 3.5 and ranges therein. X, Y, and Z can be the same, but do not need to be the same or approximately the same. For example, X, Y, and Z can all be equal to one (1), X and Y can be equal to two (2) and Z can be equal to 1.5, or X and Y can be equal to three (3) and Z can be equal to two (2). In some current systems, the required alkaline conditions for the reaction can be created through the addition of one or more bases (e.g., KOH, NaOH, NH₃, NH₄OH, etc.) to the electrolyte.

In some examples, the cathode 318b is a gas permeable electrode. More specifically, the cathode 318b can be a graphite electrode, a foam, or carbon electrode that is porous, or some other CO₂ gas permeable electrode, depending on the one or more HCER catalysts 316b, that allows for the CO₂ and H⁺ reduction. The anode 306b can be a nickel foam or, depending on the OER catalysts 308a, some other type of material that allows for H₂O oxidation.

The active portion of the anode 306b is where the OER catalyst 308b is located and the active portion of the cathode 318b is where the one or more HCER catalysts 316b are located. If the electrocatalysis system 300d is a pressurized system, the OER catalysts membrane 706 can help protect the OER catalyst 308b and the HCER catalysts membrane 708 can help protect the one or more HCER catalysts 316b. In an example, the one or more HCER catalysts 316a include g-C₃N₄. In another example, the one or more HCER catalysts 316a include g-C₃N₄ and/or CoPc embedded in a CNT matrix with an IPA solvent. In a specific example, the one or more HCER catalysts 316a include g-C₃N₄ and/or CoPc embedded in a CNT matrix and Pt.

Turning to FIG. 10, FIG. 10 is a block diagram of a particular non-limiting implementation of a portion of a reaction vessel 718d that may be used in the electrocatalysis system 300e in the gas creation station 102 to help create syngas, in accordance with an embodiment of the present disclosure. The reaction vessel 718d is just one example of an aqueous flow reactor to help create syngas.

The reaction vessel 718d can include electrodes 1002a and 1002b (monopolar/bipolar plates), a proton exchange membrane 1004, a catalyst 1006 (catalyst layer), and an electrolyte 1008 (diffusion layer). An anode side 1010 of the reaction vessel 718d can include a water inlet 1012 and a water and oxygen outlet 1014. A cathode side 1016 of the reaction vessel 718d can include an optional carbon dioxide and water inlet 1018 and a water and hydrogen outlet 1020. If carbon dioxide is added through the optional carbon dioxide and water inlet 1018, the water and hydrogen outlet 1020 can also be a CO outlet.

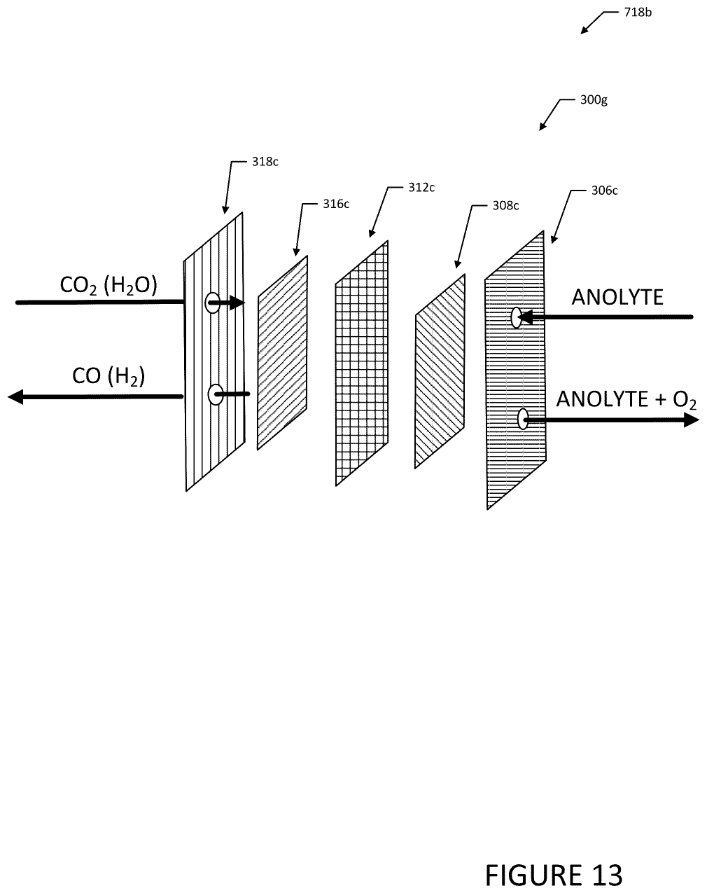

The catalyst 1006 is an HCER catalyst that allows for the CO₂ and H⁺ reduction. In an example, the catalyst 1006 includes g-C₃N₄. The g-C₃N₄ structure has repeating Lewis basic sites (the phthalocyanine-like active and binding sites) where metals, such as Cu, Ag, Au, Ni, Pd, Pt, Co, Rh, Ir, Fe, Ru, Os, or other Lewis acids can bind to modify the catalytic and/or electronic properties of the material. These binding sites can be occupied fully or partially, by one or more metals or Lewis acids, as shown in FIGS. 14-19 For example, in a specific illustrative example, about one mole percent (1%) to about thirty mole percent (30%), and ranges therein (e.g., 9.5 mole percent, 10.25 mole percent, 10.75 mole percent, etc.), of Au or Ag may be embedded in the g-C₃N₄. In another specific illustrative example, about five mole percent (5%) to about fifteen mole percent (15%), and ranges therein (e.g., 9.5 mole percent, 10.25 mole percent, 10.75 mole percent, etc.), of Au or Ag may be embedded in the g-C₃N₄. In a specific example, about ten mole percent (10%) of Au or Ag may be embedded in the g-C₃N₄. In another specific example, the catalyst 1006 includes g-C₃N₄ or a CoPc catalyst embedded into a CNT matrix. In yet another specific example, the catalyst 1006 includes g-C₃N₄ and the CoPc catalyst embedded into a CNT matrix. In yet another specific example, the one or more HCER catalysts 316a include g-C₃N₄ and the CoPc catalyst embedded into a CNT matrix with the addition of platinic acid (H₂PtCl₆) as a platinum (Pt) source.

One side of the reaction vessel 718d is typically (but not always) run with a “zero-gap” meaning that the electrolyte 1008 is commonly only circulated on one side of the proton exchange membrane 1004 and the other side, the catalyst 1006 is pressed directly up against or coated directly on the proton exchange membrane 1004 with no intentional void or spacing. The electrolyte 1008 then circulates on one side of the proton exchange membrane 1004, exchanges ions through the proton exchange membrane 1004, and the ions may react on the opposite side. The electrolyte 1008 may further comprise a porous material such a gas diffusion electrode, carbon paper, mesoporous oxide layer or combination thereof. The catalyst 1006 is porous to allow for gas flow and flow fields 1022a and 1022b are behind the catalyst 1006. In some examples, the catalysts 1006 may further comprise a porous material such a gas diffusion electrode, carbon paper, mesoporous oxide layer or combination thereof. In some examples, the flow fields 1022a and 1022b are embedded in the electrode. In other examples, the electrodes 1002a and 1002b are separate plates adjacent to and in contact with the flow fields 1022a and 1022b. Industrially, individual reaction vessels 718d may be stacked serially into a large (e.g., megawatt) electrolyzer and, when stacked, the electrodes 1002a and 1002b are called bipolar plates.

In an illustrative example, the electrodes 1002a and 1002b (plates) of the reaction vessel 718d are monoploar plates or bipolar plates. A monopolar plate is used for a single cell electrolyzer and is solely the cathode or anode. A bipolar plate is used in an electrolyzer stack (e.g., a commercial electrolyzer) and could, for example, act as a cathode in one cell and then as an anode in the subsequent cell or act as an anode in one cell and then as a cathode in the subsequent cell. This alternation allows for several cells to be stacked together and function concurrently in series.

Turning to FIG. 11, FIG. 11 is a block diagram of a portion of a reaction vessel 718e in the electrocatalysis system 300f to help create syngas, in accordance with an embodiment of the present disclosure. The reaction vessel 718e is just one example of an aqueous flow reactor to help create syngas.

The reaction vessel 718e can include electrodes 1102a and 1102b (monopolar/bipolar plates), an anion exchange membrane 1104, a catalyst 1106 (catalyst layer), and an electrolyte 1108 (diffusion layer). An anode side 1110 of the reaction vessel 718e can include a water inlet 1112 and a water and oxygen outlet 1114. A cathode side 1116 of the reaction vessel 718e can include an optional carbon dioxide and water inlet 1118 and a water and hydrogen outlet 1120. If carbon dioxide is added through the optional carbon dioxide and water inlet 1118, the water and hydrogen outlet 1120 can also be a CO outlet.

The catalyst 1106 is an HCER catalyst that allows for the CO₂ and H⁺ reduction. In an example, the catalyst 1106 includes g-C₃N₄. The g-C₃N₄ structure has repeating Lewis basic sites (the phthalocyanine-like active and binding sites) where metals, such as Cu, Ag, Au, Ni, Pd, Pt, Co, Rh, Ir, Fe, Ru, Os, or other Lewis acids can bind to modify the catalytic and/or electronic properties of the material. These binding sites can be occupied fully or partially, by one or more metals or Lewis acids, as shown in FIGS. 14-19. For example, in a specific illustrative example, about one mole percent (1%) to about thirty mole percent (30%), and ranges therein (e.g., 9.5 mole percent, 10.25 mole percent, 10.75 mole percent, etc.), of Au or Ag may be embedded in the g-C₃N₄. In another specific illustrative example, about five mole percent (5%) to about fifteen mole percent (15%), and ranges therein (e.g., 9.5 mole percent, 10.25 mole percent, 10.75 mole percent, etc.), of Au or Ag may be embedded in the g-C₃N₄. In a specific example, about ten mole percent (10%) of Au or Ag may be embedded in the g-C₃N₄. In another specific example, the catalyst 1106 includes g-C₃N₄ or a CoPc catalyst embedded into a CNT matrix. In yet another specific example, the catalyst 1106 includes g-C₃N₄ and the CoPc catalyst embedded into a CNT matrix. In yet another specific example, the one or more HCER catalysts 316a include g-C₃N₄ and the CoPc catalyst embedded into a CNT matrix with the addition of platinic acid (H₂PtCl₆) as a platinum (Pt) source.

One side of the reaction vessel 718e is typically (but not always) run with a zero-gap such that the electrolyte 1108 and 1108 is commonly only circulated on one side of the anion exchange membrane 1104, and the other side, the catalyst 1106 is pressed directly up against or directly coated on the anion exchange membrane 1104 with no intentional void or spacing. The electrolyte 1108 and 1108 then circulates on one side of the anion exchange membrane 1104, exchanges ions through the anion exchange membrane 1104, and the ions may react on the opposite side. The electrolyte 1008 may further comprise a porous material such a gas diffusion electrode, carbon paper, mesoporous oxide layer or combination thereof. The catalyst 1106 is porous to allow for gas flow and flow fields 1112a and 1112b are behind the catalyst 1106. In some examples, the catalysts 1006 may further comprise a porous material such a gas diffusion electrode, carbon paper, mesoporous oxide layer or combination thereof. In some examples, the flow fields 1112a and 1112b are embedded in the electrodes 1102a and 1102b. In other examples, the electrodes 1102a and 1102b are separate plates adjacent to and in contact with the flow fields 1112a and 1112b. Industrially, individual reaction vessels 718e may be stacked serially into a large (e.g., megawatt) electrolyzer and, when stacked, the electrodes 1102a and 1102b are called bipolar plates.

In an illustrative example, the electrodes 1102a and 1102b (plates) of the reaction vessel 718e are monoploar plates or bipolar plates. A monopolar plate is used for a single cell electrolyzer and is solely the cathode or anode. A bipolar plate is used in an electrolyzer stack (e.g., a commercial electrolyzer) and could, for example, act as a cathode in one cell and then as an anode in the subsequent cell or act as an anode in one cell and then as a cathode in the subsequent cell. This alternation allows for several cells to be stacked together and function concurrently in series.

Turning to FIG. 12, FIG. 12 is an illustrates example details of a particular non-limiting implementation of a portion of a zero gap PEM or AEM electrolyzer 1202, in accordance with an embodiment of the present disclosure. The zero gap PEM or AEM electrolyer 1202 can include a first electrode (anode) 1204, an electrolyte 1206, an OER mesoporous layer 1208, an OER catalyst layer 1210, a membrane 1212, an HCER catalyst 1214, a GDE 1216, and a second electrode (cathode) 1218. The OER mesoporous layer 1208 can include nanoparticulate OER catalyst particles or an OER catalyst coated on a mesoporous layer particle support. The mesoporous layer particle support may be any nanoparticle in a continuous or discontinuous layer onto which the OER catalyst can be coated by vapor deposition, sputtering, solution based coating, or other deposition means. The mesoporous layer particle support can include, for example, oxides of titanium, zirconium, hafnium, vandium, niobium, tantalum, aluminum, silicon, tungsten, nickel, ruthenium, irirdium, zine, and tin. The GDE 1216 may be a standalone layer or may be further coated with the HCER catalyst 1214.

The HCER catalyst 1214 may be in direct contact with the membrane and/or coated directly on the membrane. In some examples, the HCER catalyst 1214 includes g-C₃N₄. In some examples, metals, such as Cu, Ag, Au, Ni, Pd, Pt, Co, Rh, Ir, Fe, Ru, Os, or other Lewis acids may be used to modify the catalytic and/or electronic properties of the g-C₃N₄. For example, in a specific illustrative example, about one mole percent (1%) to about thirty mole percent (30%), and ranges therein (e.g., 9.5 mole percent, 10.25 mole percent, 10.75 mole percent, etc.), of Au or Ag may be embedded in the g-C₃N₄. In another specific illustrative example, about five mole percent (5%) to about fifteen mole percent (15%), and ranges therein (e.g., 9.5 mole percent, 10.25 mole percent, 10.75 mole percent, etc.), of Au or Ag may be embedded in the g-C₃N₄. In a specific example, about ten mole percent (10%) of Au or Ag may be embedded in the g-C₃N₄. In a specific example, the HCER catalyst 1214 can include the g-C₃N₄ and CoPc. In some examples, the g-C₃N₄ and the CoPc may be embedded into a CNT matrix for electrical conductivity. In some examples, if the CoPc is used, hydrogen reduction may be further promoted by addition of Pt.

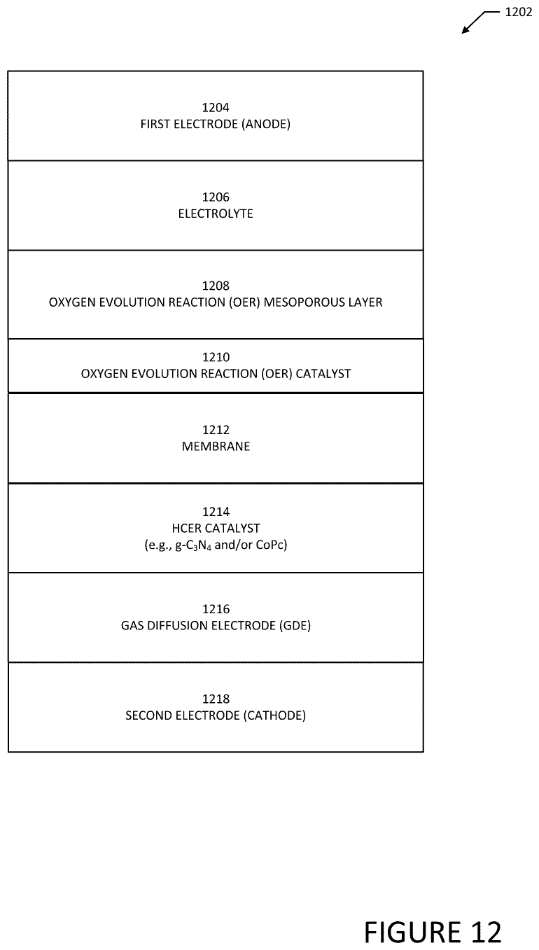

Turning to FIG. 13, FIG. 13 is an exploded view of a particular non-limiting implementation of a portion of a reaction vessel 718b in an electrocatalysis system 300g in the gas creation station 102 to help create syngas, in accordance with an embodiment of the present disclosure. The electrocatalysis system 300g is just one example of an aqueous flow reactor to help create syngas. As illustrated in FIG. 13, the electrocatalysis system 300g can include an anode 306c, one or more OER catalysts 308c, a first electrolyte (not shown), a membrane 312c, a second electrolyte (not shown), one or more HCER catalysts 316c, and a cathode 318c. The membrane 312c can be a cation exchange membrane. In the electrocatalysis system 300g, the use of catholyte and anolyte are options and depend on the design of the reactor and user choice. Note that in the configuration illustrated in FIG. 12, the anolyte is commonly present. In a “zero-gap configuration,” the membrane performs additionally as a solid state catholyte and a liquid catholyte is not included. The CO₂ may be introduced as a pure gas or mixed with other gases such as H₂O.

The desired reaction in the electrocatalysis system 300g is:

XH₂O+CO₂→YH₂+CO+ZO₂

X, Y, and Z can have values from about 0.1 to about 3.5 and ranges therein. X, Y, and Z can be the same, but do not need to be the same or approximately the same. For example, X, Y, and Z can all be equal to one (1), X and Y can be equal to two (2) and Z can be equal to 1.5, or X and Y can be equal to three (3) and Z can be equal to two (2). In some current systems, the required acidic conditions for the reaction must be created through the addition of other acids (e.g., HCl, HNO₃ and H₂SO₄) to the electrolyte.

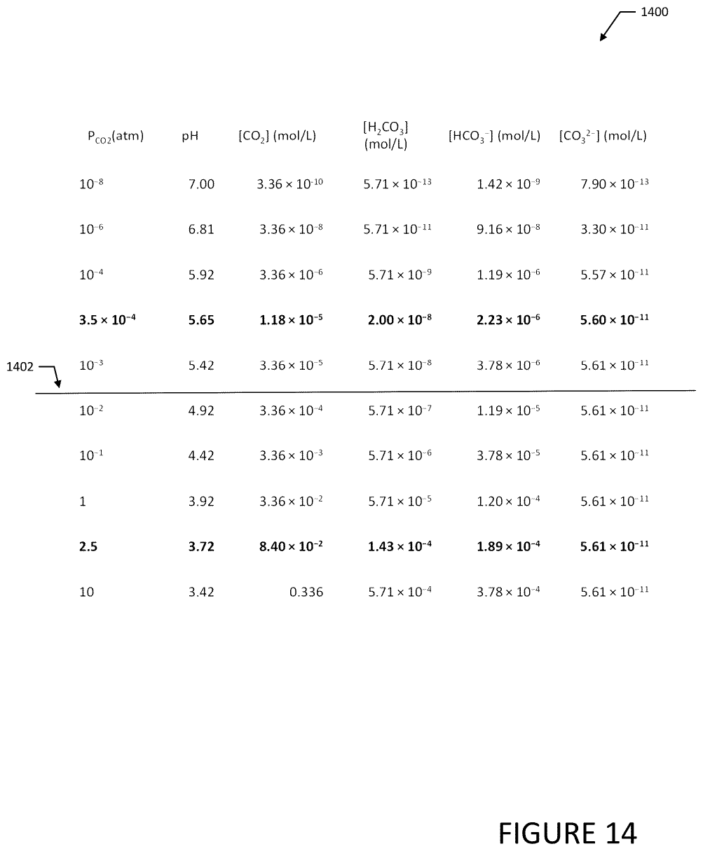

In some examples, the cathode 318c is a gas permeable electrode. More specifically, the cathode 318c can be a graphite electrode, a foam, or carbon electrode that is porous, or some other CO₂ gas permeable electrode, depending on the one or more HCER catalysts 316c, that allows for the CO₂ and H₂ reduction. The anode 306c can be a nickel foam or, depending on the OER catalysts 308c, some other type of material that allows for H₂O oxidation. The active portion of the anode 306c is where the OER catalyst 308c is located and the active portion of the cathode 318c is where the one or more HCER catalysts 316c are located. If the electrocatalysis system 300c is a pressurized system, an OER catalysts membrane can help protect the OER catalyst 308c and an HCER catalysts membrane can help protect the one or more HCER catalysts 316c. In an example, the one or more HCER catalysts 316a include g-C₃N₄. The g-C₃N₄ structure has repeating Lewis basic sites (the phthalocyanine-like active and binding sites) where metals, such as Cu, Ag, Au, Ni, Pd, Pt, Co, Rh, Ir, Fe, Ru, Os, or other Lewis acids can bind to modify the catalytic and/or electronic properties of the material. These binding sites can be occupied fully or partially by one or more metals or Lewis acids, as shown in FIGS. 15-120.

Turning to FIG. 14, FIG. 14 is a simplified table 1400 illustrating example details relating to reactions in a reaction vessel 718 of the electrocatalysis system 300 in the gas creation station 102 to help create syngas, in accordance with an embodiment of the present disclosure. As illustrated in FIG. 14, the table 1400 can include an equilibrium breakover point 1302. The equilibrium breakover point 1302 represents a pressure of the CO₂ at about 10⁻² atm or slightly above about 10⁻² atm. Once the pressure of the CO₂ in the reaction vessel 718 of the electrocatalysis system 300 is past the past equilibrium breakover point 1302, the left side of the equation CO_{2(aq)}+H₂O→H₂CO₃ becomes saturated meaning the carbonic acid is in equilibrium with a proton and bicarbonate and a low enough pH is created to run the reaction for syngas production without adding external additional catholyte and/or additional anolyte or any external electrolyte or acid.

Turning to FIG. 15, FIG. 15 is a simplified graph 1500 illustrating particular non-limiting example details of H₂, CO, and CH₄ distributions at different current densities. In an example, syngas was created using ten percent (10%) gold-incorporated graphitic carbon nitride (Au—C₃N₄) as a catalyst. As illustrated by the graph 1500, the H₂/CO ratio during creation of the syngas can be tuned by changing the applied current density.

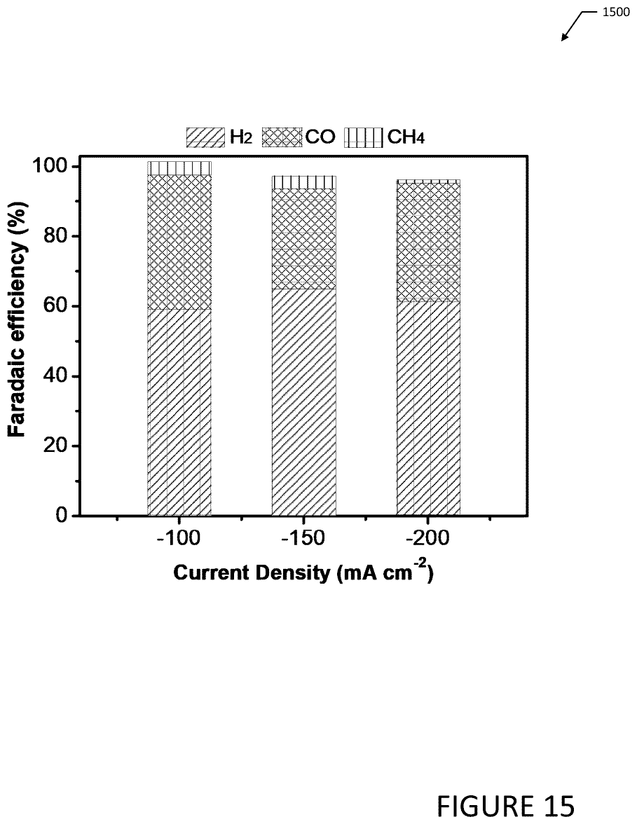

Turning to FIG. 16, FIG. 16 is a simplified graph 1600 illustrating particular non-limiting example details of H₂, CO, and CH₄ distributions at different CO₂ flow rates. In an example, syngas was created using ten percent (10%) Au—C₃N₄ as a catalyst. As illustrated by the graph 1600, the H₂/CO ratio during creation of the syngas can be tuned by changing the CO₂ flow rate.

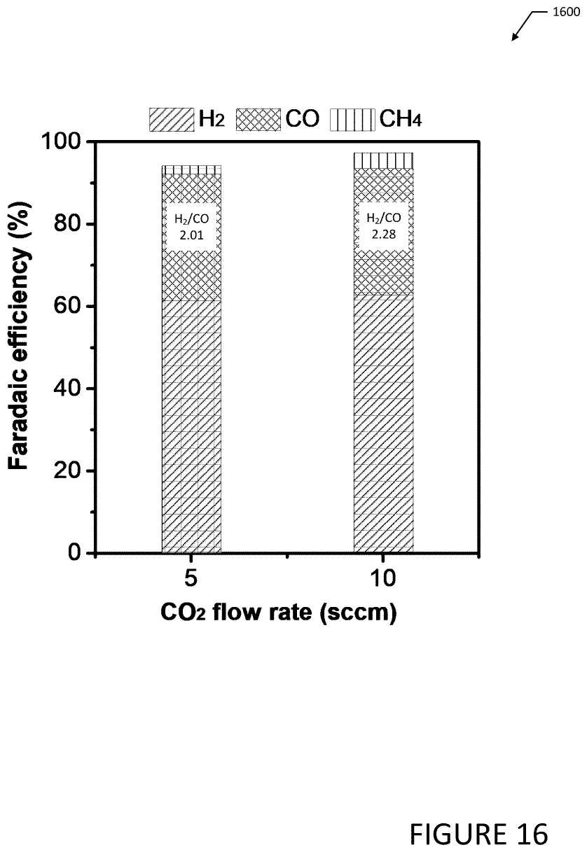

Turning to FIG. 17, FIG. 17 are simplified graphs 1700 and 1602 illustrating particular non-limiting example details of the durability of the ten percent (10%) Au—C₃N₄ catalyst. The graphs 1600 and 1602 were created using a CO₂ reduction at-150 mA cm-2 using pH 2 K₂SO₄ catholyte and a H₂SO₄ anolyte. As shown by the graphs 1600 and 1602, the ten percent (10%) Au—C₃N₄ catalyst delivered relatively excellent durability during a one-hundred and twenty (120) hour CO₂ reduction in the relatively harsh catholyte and anolyte reaction conditions. As shown in the graph 1600, the H₂/CO ratio was stabilized around 2. Note that the H₂/CO ratio can be adjusted or tuned by changing the applied current density and/or the CO₂ flow rate.

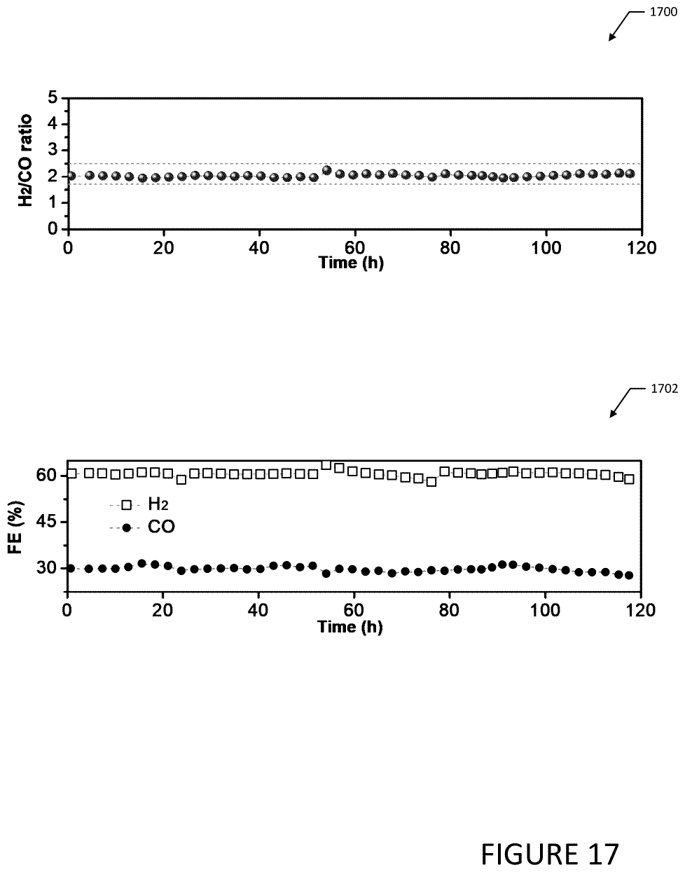

Turning to FIG. 18, FIG. 18 is a simplified graph 1800 illustrating particular non-limiting example details of H₂, CO, and CH₄ distributions at different current densities. In an example, syngas was created using ten percent (10%) silver-incorporated graphitic carbon nitride (Ag—C₃N₄) as a catalyst. As illustrated by the graph 1800, the H₂/CO ratio during creation of the syngas can be tuned by changing the applied current density. In addition, as shown in FIG. 18, the loading amount of the metallic Ag can also be used to tune the H₂/CO ratio where reducing the Ag concentration favors H₂ formation.

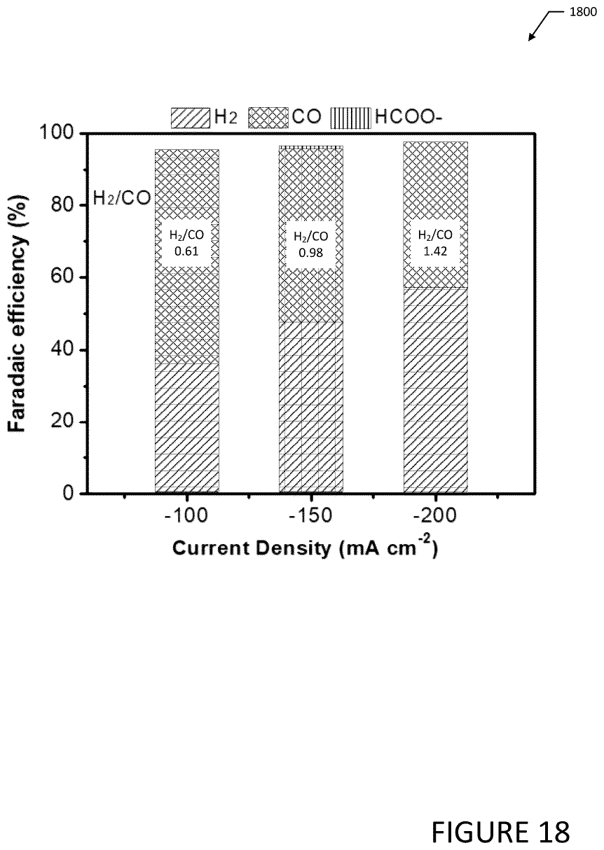

Turning to FIG. 19, FIG. 19 is a simplified graph 1900 illustrating particular non-limiting example details of H₂, CO, and CH₄ distributions at different current densities. In an example, syngas was created using 2.5 percent (2.5%) Ag—C₃N₄ as a catalyst. As illustrated by the graph 1900, the H₂/CO ratio during creation of the syngas can be tuned by changing the applied current density. Note that 2.5 percent (2.5%) Ag—C₃N₄ was used to tune the H₂/CO ratio towards an increase of H₂ formation as compared to using ten percent (10%) Ag—C₃N₄ as illustrated in FIG. 18.

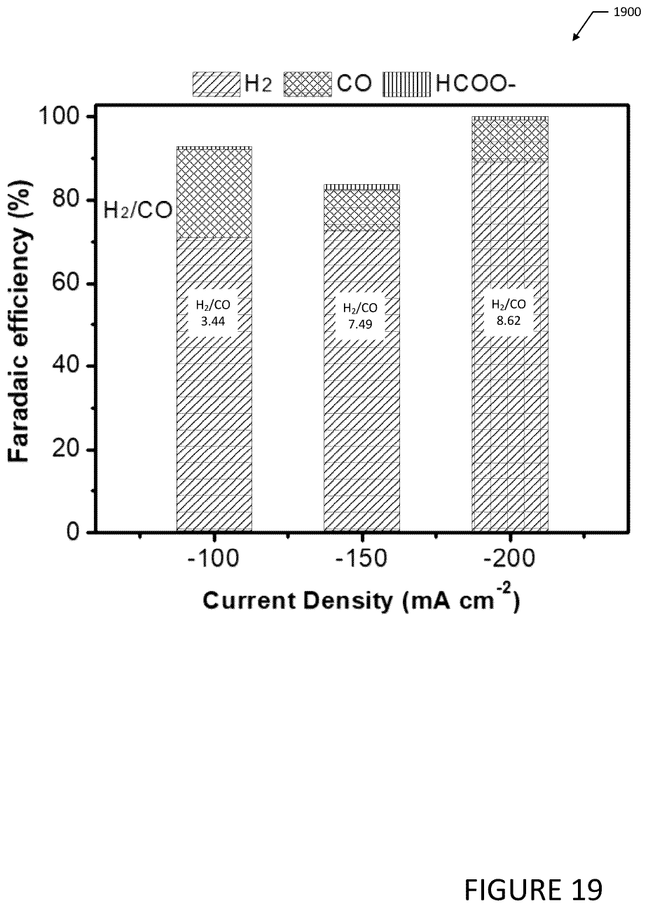

Turning to FIG. 20, FIG. 20 is a simplified graph illustrating particular non-limiting example details of using a bare C₃N₄ catalyst at different current densities. As illustrated in FIG. 20, the bare C₃N₄ catalyst produces H₂ as the dominate product during the CO₂ reduction reaction.

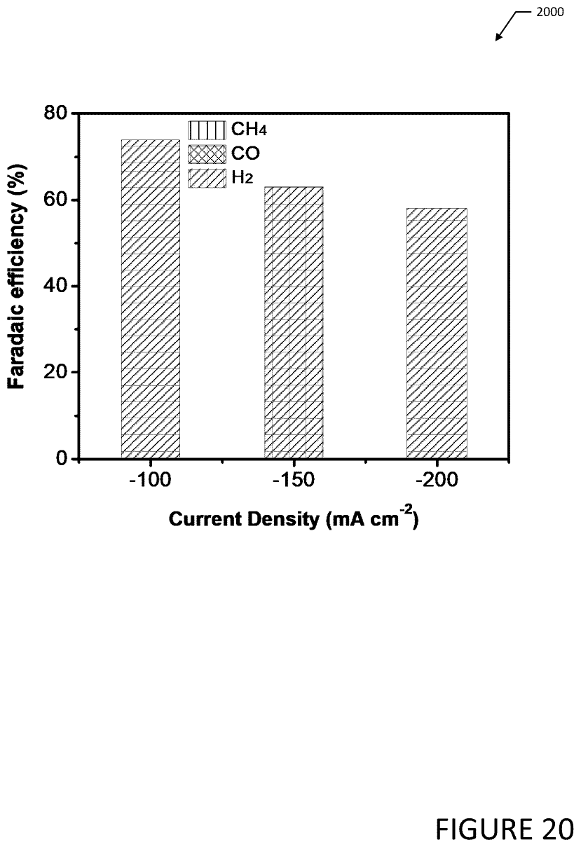

Turning to FIG. 21, FIG. 21 is a simplified diagram illustrating the structure of g-C₃N₄ 2100. The typical form of g-C₃N₄ is a polymeric material with a repeating unit of C₆N₉H₃. g-C₃N₄ has a two-dimensional (2D) sheet structure with a delocalized conjugated structure. The structure of g-C₃N₄ 2100 is made up of two basic units, tri-s-triazine rings (C6N7) 2102 and triazine rings (C3N3) 2104 and, that extend infinitely to form a network structure. The stacking layers of g-C3N4 are bound together by van der Waals forces, similar to the layers in graphite, and the tri-s-triazine rings are connected by planar amino groups. The weak interlayer bonding of g-C₃N₄ allows for easy exfoliation into thinner sheets or even single layers, enhancing the surface area and catalytic activity. g-C₃N₄ has a layered structure similar to graphite, but with nitrogen atoms incorporated into the carbon lattice forming phthalocyanine-like active and binding sites. The g-C₃N₄ structure has repeating Lewis basic sites (the phthalocyanine-like active and binding sites) where metals, such as Cu, Ag, Au, Ni, Pd, Pt, Co, Rh, Ir, Fe, Ru, Os, or other Lewis acids can bind to modify the catalytic and/or electronic properties of the material. These binding sites can be occupied fully or partially, by one or more metals or Lewis acids.

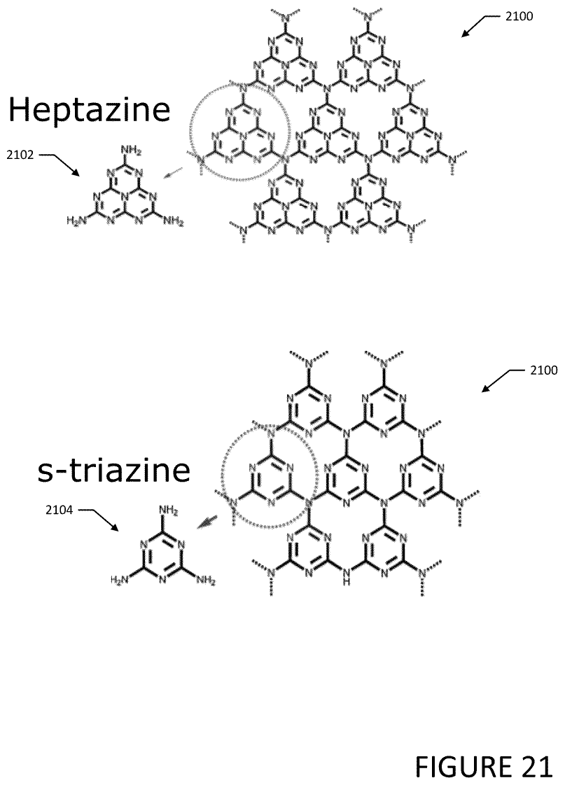

Turning to FIG. 22, FIG. 22 is an example flowchart illustrating possible operations of a flow 2200 that may be associated with enabling the creation of synthetic fuel, in accordance with an embodiment. At 2202, carbon dioxide is extracted from the atmosphere and converted to syngas. For example, the gas creation station 102 can extract CO₂ from the atmosphere and convert the extracted CO₂ to syngas. In some examples, the power station 108 can help provide power to the gas creation station 102. At 2204, the syngas is used in the creation of heavy syncrude. For example, the created syngas can be sent to the crude creation station 104 and the crude creation station 104 can use the syngas to create heavy syncrude. At 2106, the heavy syncrude is cracked to create synthetic fuels. For example, the heavy syncrude can be sent to the crude refining station 106 and the crude refining station 106 can convert the heavy syncrude into synthetic fuel.

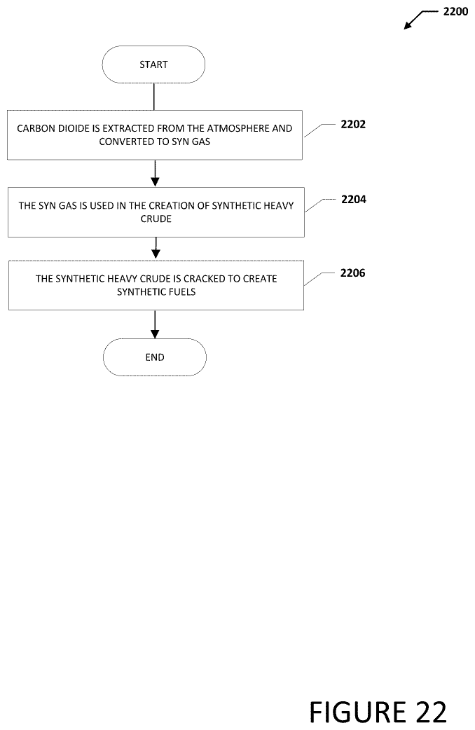

Turning to FIG. 23, FIG. 23 is an example flowchart illustrating possible operations of a flow 2300 that may be associated with enabling the creation of synthetic fuel, in accordance with an embodiment. At 2302, carbon dioxide is extracted from the atmosphere and converted to syngas using co-electrocatalysis. For example, the gas creation station 102 can extract CO₂ from the atmosphere and convert the extracted CO₂ to syngas using co-electrocatalysis. In some examples, g-C₃N₄ can be used as an HCER catalyst in an electrolyzer to form the syngas. In some examples, the power station 108 is a renewable energy power station that can help provide power to the gas creation station 102. At 2304, the syngas is used in a Fischer-Tropsch synthesis reaction to create heavy syncrude. For example, the created syngas can be sent to the crude creation station 104 and the crude creation station 104 can use the syngas in a Fischer-Tropsch synthesis reaction to create heavy syncrude. At 2306, the heavy syncrude is cracked to create synthetic fuels. For example, the heavy syncrude can be sent to the crude refining station 106 and the crude refining station 106 can convert the heavy syncrude into synthetic fuel.

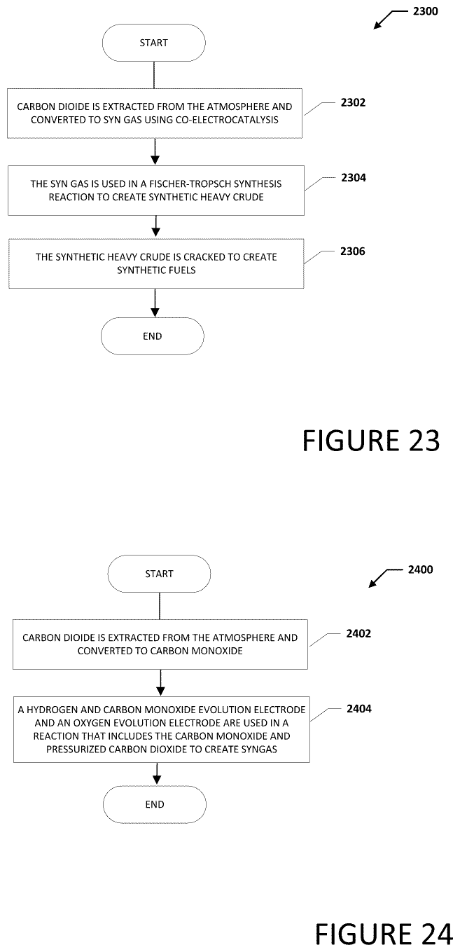

Turning to FIG. 24, FIG. 24 is an example flowchart illustrating 6possible operations of a flow 2400 that may be associated with enabling the creation of syngas, in accordance with an embodiment. At 2402, carbon dioxide is extracted from the atmosphere and converted to carbon monoxide. For example, the gas creation station 102 can extract CO₂ from the atmosphere and convert the extracted CO₂ to CO. At 2404, a hydrogen and carbon monoxide evolution electrode and an oxygen evolution electrode are used in a reaction that include the carbon monoxide and pressurized carbon dioxide to create syngas. For example, the anode 306 (acting as an oxygen evolution electrode), one or more OER catalysts 308, one or more HCER catalysts 316, and the cathode 318 (acting as a hydrogen and carbon monoxide evolution electrode) can be used in a reaction that includes the CO and pressurized CO₂ to create syngas. In some examples, the one or more HCER catalysts 316 can include g-C₃N₄. In other examples, the one or more HCER catalysts 316 can include g-C₃N₄ and/or CoPc.

Note that with the examples provided herein, interaction may be described in terms of one, two, three, or more elements. However, this has been done for purposes of clarity and example only. In certain cases, it may be easier to describe one or more of the functionalities by only referencing a limited number of elements. It should be appreciated that the synthetic fuel creation system 100 and its teachings are readily scalable and can accommodate a large number of components, as well as more complicated/sophisticated arrangements and configurations. Accordingly, the examples provided should not limit the scope or inhibit the broad teachings of the synthetic fuel creation system 100 and potentially applied to a myriad of other architectures.

It is also important to note that the operations in the preceding flow diagrams (i.e., FIGS. 20-22) illustrate only some of the possible correlating scenarios and patterns that may be executed, some of these operations may be deleted or removed where appropriate, or these operations may be modified or changed considerably without departing from the scope of the present disclosure. In addition, the timing of these operations may be altered considerably. The preceding operational flows have been offered for purposes of example and discussion. Substantial flexibility is provided in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although the synthetic fuel creation system 100 has been illustrated with reference to particular elements and operations, these elements and operations may be replaced by any suitable architecture, protocols, and/or processes that achieve the intended functionality of the synthetic fuel creation system 100.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. For example, the g-C₃N₄ catalyst and/or the CoPc catalyst embedded into a CNT matrix can be used in other applications other than the ones discussed herein and may be used in other electrolyzer reactor types and/or other reactions other than the ones discussed herein. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. An electrocatalysis system to create syngas, the electrocatalysis system comprising:
an anode;
a cathode;
one or more oxygen evolution reaction catalysts;
one or more hydrogen/carbon monoxide evolution reaction (HCER) catalysts, wherein at least one of the HCER catalysts is a graphitic carbon nitride; and
an electrolyte.

2. The electrocatalysis system of claim 1, wherein the graphitic carbon nitride HCER catalyst is a gold-incorporated graphitic carbon nitride.

3. The electrocatalysis system of claim 1, wherein the graphitic carbon nitride HCER catalyst is a silver-incorporated graphitic carbon nitride.

4. The electrocatalysis system of claim 1, wherein a renewable energy power station helps to power the reaction to create the syngas.

5. The electrocatalysis system of claim 1, wherein the syngas is created using a photovoltaic (PV)-driven electrocatalysis system.

6. The electrocatalysis system of claim 1, wherein the syngas is created using a photovoltaic-divorced electrocatalysis system (PV-EC).

7. The electrocatalysis system of claim 1, wherein the syngas is created using a PV-integrated electrocatalysis system (PVIE).

8. The electrocatalysis system of claim 7, wherein the PVIE includes a two terminal (2T) tandem PV device.

9. The electrocatalysis system of claim 1, wherein a bimetallic catalyst is used in the reaction to create the syngas.

10. The electrocatalysis system of claim 1, wherein a pH of the electrolyte is acidic during at least a portion of creation of the syngas and pressurized CO₂ is used to create acidic conditions of the electrolyte.

11. The electrocatalysis system of claim 1, wherein the electrocatalysis system uses CO₂ from air that is captured using a direct air capture (DAC) system.

12. A synthetic fuel creation system comprising:
a syngas creation station, wherein the syngas creation station uses a hydrogen and carbon monoxide evolution electrode, a graphitic carbon nitride hydrogen/carbon monoxide evolution reaction (HCER) catalysts, and an oxygen evolution electrode in a reaction to create syngas;
a crude creation station wherein the crude creation station uses the syngas and one or more catalysts to create heavy syncrude; and
a crude refining station, wherein the crude refining station converts the heavy syncrude into synthetic fuel.

13. The synthetic fuel creation system of claim 12, wherein the graphitic carbon nitride HCER catalyst is a ten percent by weight gold-incorporated graphitic carbon nitride.

14. The synthetic fuel creation system of claim 12, wherein the graphitic carbon nitride HCER catalyst is a ten percent by weight silver-incorporated graphitic carbon nitride.

15. The synthetic fuel creation system of claim 12, wherein the reaction to create the syngas occurs in acidic conditions.

16. The synthetic fuel creation system of claim 12, wherein the syngas is created using a PV-driven electrocatalysis system.

17. A method for creating syngas, the method comprising:
converting CO₂ to CO; and
using a hydrogen and carbon monoxide evolution electrode, a graphitic carbon nitride hydrogen/carbon monoxide evolution reaction (HCER) catalysts, and an oxygen evolution electrode in a reaction to create syngas.

18. The method of claim 17, wherein the graphitic carbon nitride HCER catalyst is a gold-incorporated graphitic carbon nitride.

19. The method of claim 17, wherein the graphitic carbon nitride HCER catalyst is a silver-incorporated graphitic carbon nitride.

20. The method of claim 17, wherein a renewable energy power station powers the reaction to create the syngas.
